(19) United States
(12) Patent Application Publication
(10) Pub. No.: US 2006/0039272 A1
(43) Pub. Date: Feb. 23, 2006

(54) Multi-band wideband transmission methods and apparatus having improved user capacity

(76) Inventors: Divaydeep Sikri, Harrison, NJ (US); Shaomin Samuel Mo, Monmouth Junction, NJ (US); Alexander D. Gelman, Smallwood, NY (US); Alexander M. Haimovich, North Brunswick, NJ (US)

Correspondence Address: RATNERPRESTIA, P O BOX 980, VALLEY FORGE, PA, 19482-0980, US

(21) Appl. No.: 10/924,165

(22) Filed: Aug. 23, 2004

(51) Int. Cl. H04J 11/00; H04B 7/00; H04B 1/713; H04B 1/707; H04B 1/69

(52) U.S. Cl. 370/208; 370/310

(57) ABSTRACT

Methods and computer program products for transmitting and receiving encoded signals in a wideband communication system and for generating codes for encoding the encoded signals are disclosed. The wideband communication system includes communication slots separated in frequency and/or time. The codes include components associated with each of the communication slots. A sub-carrier symbol is encoded by combining that symbol with each component of the code and modulating each symbol/component combination onto a wideband signal pulse in the communication slot corresponding to the respective component.

### FIELD OF THE INVENTION

The present invention relates to the field of wireless communication and, more particularly, to multi-band wideband transmission methods and apparatus having improved user capacity.

### BACKGROUND OF THE INVENTION

Ultra Wideband (UWB) systems use base-band pulses of very short duration to spread the energy of transmitted signals very thinly from near zero to several GHz. “Multi-band” modulation techniques have been developed for use with UWB systems. In multi-band UWB (MB-UWB) systems, the UWB frequency band is divided into multiple sub-bands (i.e., band-1 to band-N) utilizing a waveform in each sub-band. A symbol-to-band mapping component in a transmitter maps a data stream to the multi-bands for transmission and a band-to-symbol mapping component in a receiver reverses the mapping. MB-UWB systems typically employ orthogonal frequency division multiplexing (OFDM). In such systems, the UWB frequency band is divided into sub-bands and OFDM modulation is applied to each sub-band.

A piconet, e.g., a personal area network, includes at least two devices (such as a portable PC and a cellular phone) that communicate with each other over a physical layer (which may be wired and/or wireless). Presently, MB-UWB systems are under consideration by the Institute of Electrical and Electronic Engineers (IEEE) as an alternative wireless physical layer technology. Proposed MB-UWB systems are limited to four or fewer simultaneously operating piconets due to collision between the piconets resulting from a limited number of sub-bands for initial MB-UWB systems, e.g., three sub-bands.

The wireless industry envisions a “wireless home” in which a large number of consumer audio/video devices and other electronic devices within a home (such as facsimile machines, printers, refrigerators, microwaves, thermostats, etc. . . . ) each communicate with one another. To realize this vision, physical layer technologies such as MB-UWB need to handle many more simultaneously operating piconets than those that presently exist. Accordingly, improved MB-UWB methods and apparatus are needed for accommodating more simultaneously operating piconets. The present invention addresses this need among others.

### SUMMARY OF THE INVENTION

The present invention is embodied in methods and computer program products for transmitting and receiving encoded signals in a wideband communication system and for generating codes for encoding the encoded signals. The wideband communication system includes communication slots separated in frequency and/or time. The codes include components associated with each of the communication slots. A sub-carrier symbol is encoded by combining that symbol with each component of the code and modulating each symbol/component combination onto a wideband signal pulse in the communication slot corresponding to the respective component.

### BRIEF DESCRIPTION OF THE DRAWINGS

The invention is best understood from the following detailed description when read in connection with the accompanying drawings, with like elements having the same reference numerals. When a plurality of similar elements is present, a single reference numeral may be assigned to the plurality of similar elements with a small letter designation referring to specific elements. When referring to the elements collectively or to a non-specific one or more of the elements, the small letter designation may be dropped. The letter “n” may represent a non-specific number of elements. Included in the drawings are the following figures:

FIG. 1 is a block diagram of an exemplary multi-band wideband communication system in accordance with the present invention;

FIG. 2 is a block diagram of an exemplary transmitter in accordance with the present invention;

FIG. 3 is a block diagram of an exemplary receiver in accordance with the present invention;

FIG. 4 is a block diagram of an exemplary receiver/decoder for use in the exemplary receiver of FIG. 3;

FIG. 5 is a block diagram of an exemplary code generation unit for use in the exemplary receiver/decoder of FIG. 4;

FIG. 6 is a flow chart of exemplary processing steps for transmitting multi-band wideband signals in accordance with the present invention;

FIG. 7 is a flow chart of exemplary processing steps for receiving multi-band wideband signals in accordance with the present invention;

FIG. 8 is a flow chart of exemplary processing steps for generating codes for encoding and decoding multi-band wideband signals in accordance with the present invention;

FIG. 9 is a simplified block diagram of a receiver in accordance with the present invention;

FIG. 10 is an block diagram illustrating an exemplary receiver operation in accordance with the present invention;

FIG. 11 is a graph depicting error due to narrowband interference where the interference exist in all the communication slots and the signal to interference ratio is −10 dB for a system with eleven remote devices and nine communication slots;

FIG. 12 is a graph depicting error for constant, unknown, and no narrowband interference where the interference exists in a single frequency band and along all time slots and the signal to interference ratio is −10 dB for a system with eleven remote devices and nine communication slots;

FIG. 13 is a graph depicting error for constant, unknown, and no narrowband interference where the interference exists in all communication slots and the signal to interference ratio is −5 dB for a system with eleven remote devices and nine communication slots; and

FIG. 14 is a graph depicting error for constant, unknown, and no narrowband interference where the interference exists in a single frequency band and along all time slots and the signal to interference ratio is −5 dB for a system with eleven remote devices and nine communication slots.

### DETAILED DESCRIPTION OF THE INVENTION

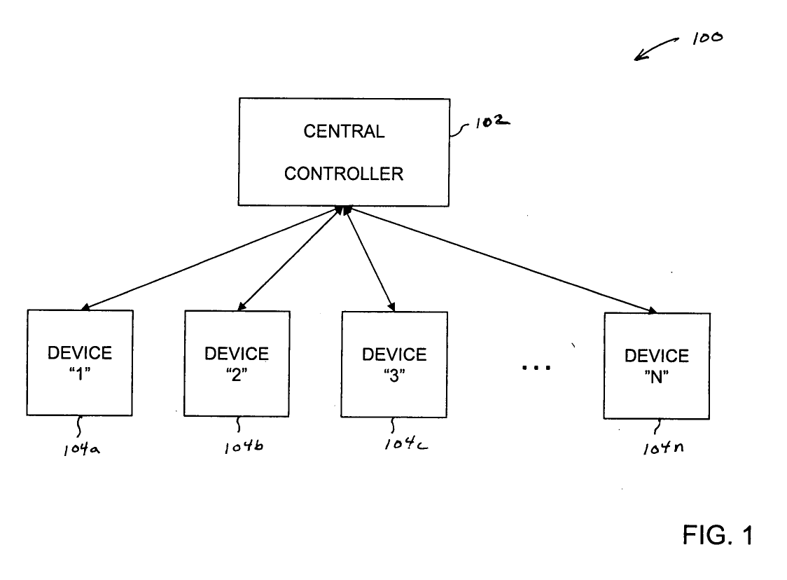

FIG. 1 is a conceptual representation of an exemplary multi-band wideband communication system 100 in accordance with the present invention. In general overview, a central controller 102 regulates the transmission of data among a plurality of remote devices (represented by devices 104a-n). In an exemplary embodiment, data transmissions between devices 104 pass through the central controller 102. The central controller 102 generates respective codes for each of the devices 104 that are used by the central controller 102 and the devices 104 to encode/decode data transmitted there between.

The devices 104 transmit each unit of data (e.g., a sub-carrier symbol within an OFDM symbol) in each of a plurality of communication slots that are separated in frequency (i.e., in different sub-bands of the multi-band wideband communication system 100) and/or time (i.e., in different time periods). An exemplary arrangement of nine (9) communication slots (i.e., Comm. Slots 1-9) arranged in 3 sub-bands over 3 separate time periods is illustrated in TABLE 1.

TABLE 1

| Frequency → | | | |
|---|---|---|---|
| (e.g., sub-band) | | | |
| 3 | Comm. Slot 3 | Comm. Slot 6 | Comm. Slot 9 |
| 2 | Comm. Slot 2 | Comm. Slot 5 | Comm. Slot 8 |
| 1 | Comm. Slot 1 | Comm. Slot 4 | Comm. Slot 7 |
| | 1 | 2 | 3 |
| | | Time Period → | |

Although nine (9) communication slots are depicted in TABLE 1, essentially any number of communication slots may be employed that cover one or more sub-bands and one or more time periods.

Each communication slot includes one or more frequency channels. A sub-carrier symbol may be transmitted in each frequency channel by modulating a wideband signal pulse associated with that channel with the sub-carrier symbol. Each wideband signal pulse is associated with a frequency, i.e., a sub-carrier frequency. In an exemplary embodiment, each communication slot includes a channel for each sub-carrier symbol of an OFDM symbol. For example, if an OFDM symbol includes 128 sub-carrier symbols, each communication slot includes 128 channels for transmitting the 128 sub-carrier symbols at 128 sub-carrier frequencies.

The central controller 102 generates a plurality of semi-orthogonal codes, each code corresponding to a respective one of the devices 104. Each data symbol transmitted by a device is convolved with the respective code for that device so that data symbols from multiple devices may be transmitted concurrently to the central controller. Likewise, each data symbol transmitted by the central controller is convolved with one of these codes so that multiple data symbols may be transmitted concurrently to multiple devices 104. In the exemplary embodiment of the invention, each code includes a plurality of components with each component corresponding to one of the communication slots. In an exemplary embodiment, each data symbol is separately coded for each of the communication slots using a respectively different component of the semi-orthogonal code.

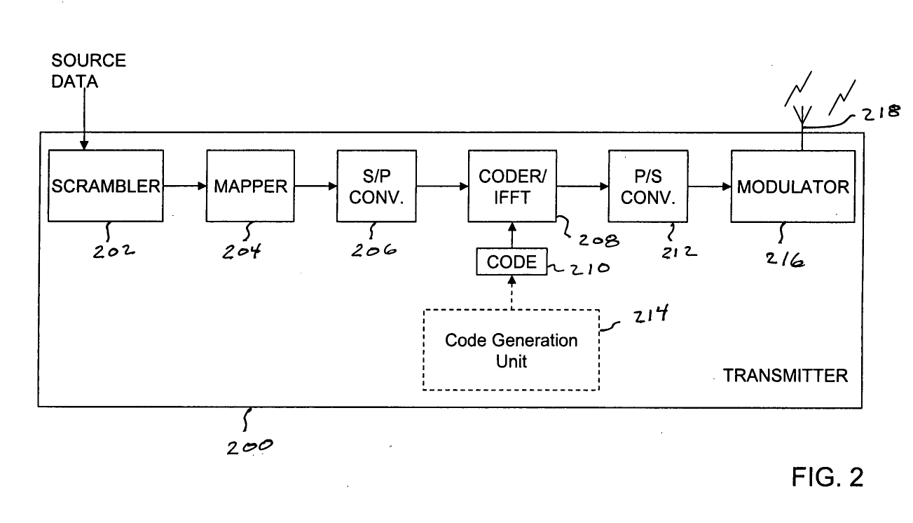

An exemplary embodiment of the present invention is now described in detail. FIG. 2 depicts an exemplary transmitter 200 for use in a device 104 (FIG. 1) to transmit data to the central controller 102 (FIG. 1) and for use in a central controller 102 to transmit data to a device 104. In an exemplary embodiment, source data is applied to a scrambler 202 that is configured to scramble the source data. The scrambler 202 may scramble all of the source data except repetitive data, e.g., synchronization words. In an exemplary embodiment, the scrambler 202 scrambles the source data using scrambling words. The scrambling words may be generated by one or more linear feedback shift registers (LFSR) such as those described in proposals to the Institute of Electrical and Electronics Engineer's (IEEE) standard IEEE 802.15.3a.

A mapper 204 coupled to the scrambler 202 receives the scrambled source data and generates data symbols responsive to the source data. In an exemplary embodiment, the mapper 204 maps source data bits to data symbols using a constellation mapping scheme such as, by way of non-limiting example, binary phase shift keying (BPSK), quadrature phase shift keying (QPSK), or quadrature amplitude modulation (QAM). The mapper 204 may perform additional known functions such as convolutional encoding, puncturing, and bit interleaving. The exemplary embodiment of the invention employs 128 QAM.

A serial-to-parallel (S/P) converter 206 converts serial data at an output port of the mapper 204 into parallel data for encoding by a coder/IFFT 208. In an exemplary embodiment, the S/P converter 206 converts the serial flow of data into parallel flow using a buffer. In this embodiment, an OFDM symbol, e.g., 128 sub-carrier symbols, may be stored in the buffer and sent concurrently to the coder/IFFT 208.

The coder/IFFT 208 is coupled to the S/P converter 206. The coder/IFFT 208 combines one or more data symbols (i.e., a sub-carrier symbol) with each component of a code 210 generated by a code generation unit 214 and performs a transformation to encode the sub-carrier symbol. In an exemplary embodiment, the transmitter 200 within the central controller 102 (FIG. 1) includes the code generation unit 214 and the transmitters 200 within the devices 104 (FIG. 1) do not include the code generation unit 214. The code generation unit 214 is represented in dashed form to indicate that it may not be present in the devices 104. In accordance with this embodiment, a code 210 for use by a device 104 may be generated by the code generation unit 218 in the central controller 102 and transmitted to the device 104 to code a sub-carrier symbol.

In an exemplary embodiment, the coder/IFFT 208 transforms data symbols from a frequency domain to one or more OFDM symbols in a time domain and maps them onto a set of orthogonal frequency sub-carriers where each constellation position is mapped to a different sub-carrier. Constellation positions mapped (or to be mapped) onto individual sub-carriers are referred to herein as “sub-carrier symbols” or “symbols.” Each OFDM symbol includes a plurality of sub-carrier symbols, e.g., 128, which corresponds to the number of sub-carriers in each communication slot of the multi-band communication system 100 (FIG. 1).

In an exemplary embodiment, each device 104 (FIG. 1) receives a unique semi-orthogonal code from the central controller 102 for coding a sub-carrier symbol for transmission. As described above, each semi-orthogonal code includes a plurality of components with each component corresponding to one of the communication slots. For example, if there are nine (9) communication slots, the code includes nine (9) components corresponding to those nine (9) communication slots. In an exemplary embodiment, the coder 214 separately codes a sub-carrier symbol using each component of the code. For example, if there are nine components, a sub-carrier symbol is coded using each of those components. More specifically, the sub-carrier symbol is coded by a first component and the same sub-carrier symbol is also coded by each of the remaining eight components. The generation of the codes by the code generation unit 214 of the central controller 102 is described in further detail below.

A parallel-to-serial (P/S) converter 212 coupled to the coder/IFFT 208 converts the encoded sub-carrier symbols from parallel to serial for modulation by the modulator 216. In an exemplary embodiment, the P/S converter 212 serializes the coded parallel OFDM symbol, e.g., the 128 sub-carrier symbols, for transmission.

The modulator 216 is coupled to the P/S converter 212. The modulator 216 modulates the coded sub-carrier symbols onto sub-carrier waves for transmission via an antenna 218. In an exemplary embodiment, OFDM symbol pulses generated by the coder/IFFT 208 may be smoothed using an interpolation function and then up-converted to match the number of frequency sub-carriers in at least a portion of a communication slot. The modulator 216 then modulates the up-converted OFDM symbol pulses onto wideband pulses of the wideband signal such as UWB pulses of a UWB signal for communication via the antenna 218.

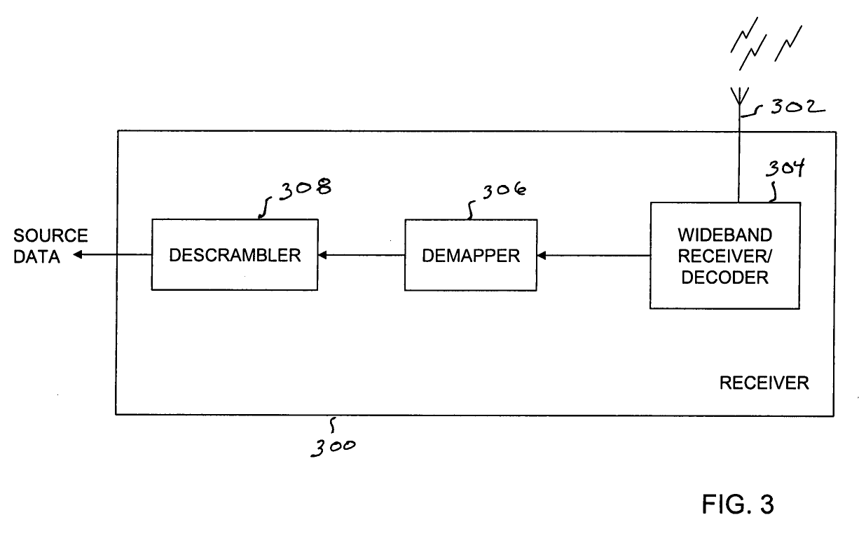

FIG. 3 depicts an exemplary receiver 300 for use in a device 104 (FIG. 1) to receive data from the central controller 102 (FIG. 1) and for use in a central controller 102 to receive data from one or more devices 104. A wideband receiver/decoder 304 within the receiver 300 receives the transmitted wideband signal through another antenna 302 and processes the wideband signal to decode the wideband signal and recover the sub-carrier symbols.

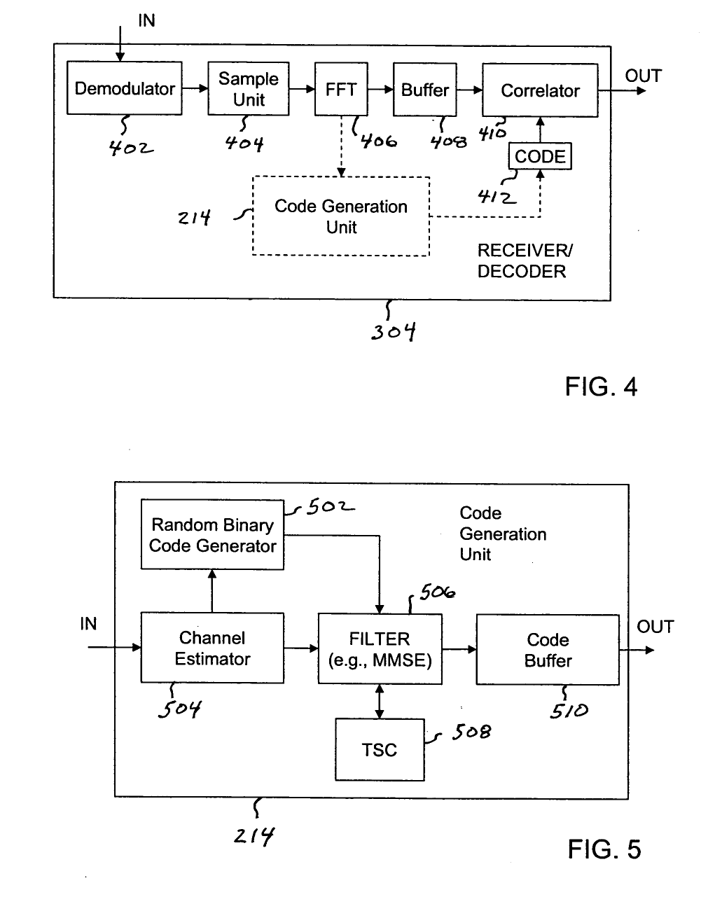

FIG. 4 depicts an exemplary receiver/decoder 304. A demodulator 402 within the receiver/decoder 302 demodulates the transmitted wideband signal from the pass band to the base band. A sample unit 404 coupled to the demodulator 402 samples the demodulated wideband signal to converts the serial data of the demodulated wideband signal to parallel data for conversion by a fast Fourier transform (FFT) 406. In an exemplary embodiment, the sample unit samples the wideband signal one complete OFDM symbol, e.g., 128 sub-carrier symbols, at a time. The FFT 406 coupled to the sample unit 404 generates OFDM symbols from the received data by taking the discrete Fourier transform (DFT) of the collected samples and transforming them from the time domain to the frequency domain.

A correlator 410 coupled to the buffer 408 correlates the received data to the pulse shape used by the transmitting apparatus 102 to identify wideband signal pulses and convert them to digital pulses. In an exemplary embodiment, the correlator 410 is a matched filter correlator configured to identify and correlate incoming frames of OFDM wideband signal pulses such as OFDM UWB pulses. In an exemplary embodiment, the correlator 410 correlates the received data by multiplying the buffered samples corresponding to each of the sub-carriers by a respective code 412 received from the code generation unit 214 of the central controller 102 (FIG. 1) and passes the result through decision logic that will be understood by one of skill in the art from the description herein.

FIG. 5 depicts an exemplary code generation unit 214 for generating codes to encode the sub-carrier symbols. The code generation unit 214 receives symbols from the FFT 406 (FIG. 4). In an exemplary embodiment, the code generation unit 214 is present within the receiver/decoder 304 of the central controller 102 (FIG. 1) and is not present within the receiver/decoder 304 of the devices 104 (FIG. 1). The code generation unit 214 is depicted in dashed form in FIG. 4 to represent that it may not be present in the devices 104.

A channel estimator 504 estimates channel characteristics associated with the channels within the communication slots. In an exemplary embodiment, the channel estimator 504 estimates the channels of each data source (device 104) using pilot symbols within an OFDM symbol. A random binary generator 502 allocates random binary codes. Suitable channel estimators and random binary generators will be understood by one of skill in the art from the description herein.

A filter 506 and a total squared correlation (TSC) unit 508 refine the codes to improve transmission performance. The codes produced by the TSC unit 508 have minimal correlation and, thus, are semi-orthogonal. In an exemplary embodiment, the filter 506 is a minimum mean square error (MMSE) filter implemented using a Lanczos algorithm, which is described in further detail below. The filter 506 filters the code selected for the device and the existing code of the device is replaced with a modified code provided by the filter. A code buffer 510 buffers the new code for delivery to the transmitter and/or receiver. A suitable TSC unit 508 for use with the present invention will be understood by one of skill in the art from the description herein. This technique offers flexibility in assigning codes depending upon the extent of flat fading. Thus, channels experiencing deep fades can be assigned codes to overcome the fading effect.

Referring back to FIG. 3, a demapper 306 coupled to the wideband receiver/decoder 304 generates the scrambled source data responsive to the data symbols. The demapper 306 may use a constellation demapping scheme such as, by was of non-limiting example, binary phase shift keying (BPSK), quadrature phase shift keying (QPSK), and quadrature amplitude modulation (QAM). The demapper 306 may perform additional known functions such as frequency domain equalization (FEQ), de-interleaving, and Viterbi decoding.

A descrambler 308 coupled to the demapper 306 receives the scrambled source data. In an exemplary embodiment, the descrambler 308 reverses the scrambling introduced to the source data by the scrambler 202 (FIG. 2) to yield the original source data. The descrambler 308 reverses the scrambling according to a predefined descrambling function that is based on the scrambling function used by the scrambler 202.

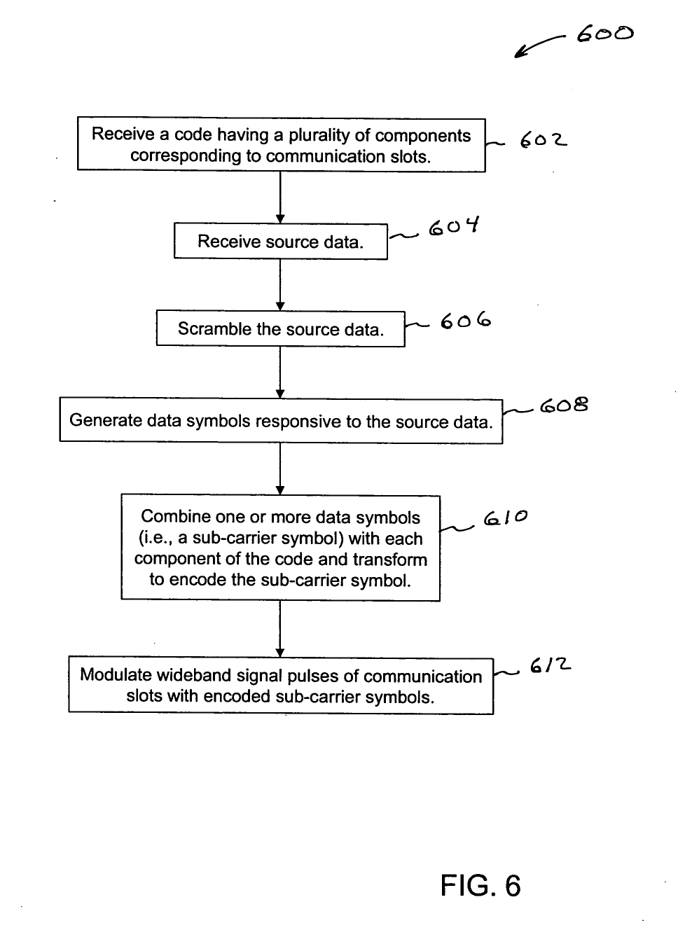

FIG. 6 depicts a flow chart 600 of exemplary processing steps for transmitting source data on wideband signal pulses of a multi-band wideband communication system such as a multi-band UWB wideband communication system. The wideband communication system includes a plurality of communication slots that are separated by time and/or frequency. Each communication slot is associated with one or more wideband signal pulses. For example, a communication slot may be associated with the number of wideband signal pulses used to transmit an entire OFDM symbol including 128 sub-carrier symbols, e.g., 128 wideband signal pulses. The steps of flow chart 600 are described with reference to the components of FIG. 2.

At block 602, the transmitter 200 receives codes for encoding symbols across the communication slots of a wideband communication system. The codes each include a plurality of components where the individual components correspond to a respective communication slot. In an exemplary embodiment, each code is unique to the transmitter of the device for a single sub-carrier symbol to be transmitted on a wideband signal pulse at a particular frequency, e.g., channel within a communication slot. The code may be received from the central controller 102 (FIG. 1) and may be periodically updated, which is described in further detail below. In an exemplary embodiment, the code is received from the code generation unit 214 in the central controller 102. Where the transmitter 200 is in the remote devices 104 and the code generation unit 214 is located in the central controller 102, the central controller 102 transmits the codes to the transmitter 200 in the remote device.

At block 604, the transmitter 200 receives the source data for transmission. At block 606, the scrambler 202 scrambles the source data. In an exemplary embodiment, the source data is scrambled according to a predetermined scrambling function, e.g., using scrambling words.

At block 608, the mapper 204 generates data symbols responsive to the source data. In an exemplary embodiment, the data symbols are in a frequency domain and are generated from the source data using a BPSK, QPSK, QAM, or other such modulation scheme.

At block 610, the coder/IFFT 208 independently combines one or more data symbols (i.e., a sub-carrier symbol) with each component of a respective code 210 (see block 602) and performs a transformation to encode the sub-carrier symbols. The transformation transforms the data symbols, which are in the frequency domain, into OFDM symbols in the time domain. In an exemplary embodiment, the coder/IFFT 208 transforms N data symbols at a time into the frame of OFDM symbols where N is the number of sub-carriers in the system. In an exemplary embodiment, the S/P converter 206 converts parallel sub-carrier symbols of an OFDM symbol into a serial stream of symbols for combining with the code. In accordance with this embodiment, the P/S converter 212 converts the stream of symbols after combination back to parallel for modulation.

At block 612, the modulator 216 modulates the encoded sub-carrier symbols onto wideband pulses of a wideband signal such as UWB pulses of a UWB signal for transmission via antenna 218. In an exemplary embodiment, the modulator 216 modulates the combined sub-carrier symbols and components of the code onto wideband signal pulses of communication slots associated with the respective component.

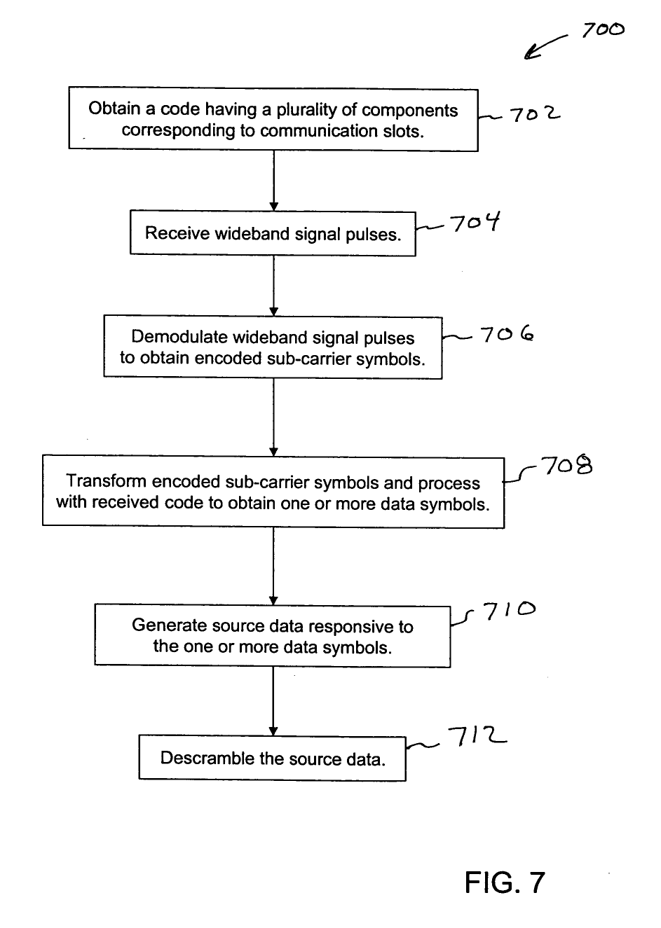

FIG. 7 depicts a flow chart 700 of exemplary steps for processing a received wideband signal in accordance with the present invention. The steps of flow chart 700 are described with reference to the components of FIGS. 1, 3, 4, and 5. At block 702, a code having a plurality of components corresponding to each of the communication slots is obtained. Where the receiver 300 is located in the central controller, the code may be generated locally. Where the receiver 300 is located in a remote device, the code may be generated at the central controller 102 and transmitted to the receiver 300 of the remote device 104.

At block 704, the wideband receiver/decoder 302 within the receiver 300 receives the transmitted wideband signal carrying the one or more encoded OFDM symbols (or sub-carrier symbols) through the antenna 302 and, at block 706, the demodulator 402 demodulates the wideband signal to covert the signal from the pass band to the base band.

At block 708, the wideband receiver/decoder 304 processes the encoded sub-carrier symbols of the demodulated wideband signal pulses for the plurality of communication slots using the codes associated with each of the one or more remote devices and perform a transformation to decode the sub-carrier symbols. The transformation converts the sub-carrier symbols from a time domain to a frequency domain. If the receiver 300 is positioned within a remote device 104, only the codes 412 for that remote device 104 are applied. If the receiver 300 is positioned within the central controller 102, the codes 412 for all of the remote devices are applied to decode the sub-carrier symbols for the respective devices.

In an exemplary embodiment, within the wideband receiver/decoder 304, the sample unit 404 samples at least one demodulated wideband signal pulse for each of the communication slots to obtain a data sample, the FFT 406 transforms the data sample from the time domain to the frequency domain, and the correlator 410 applies the codes associated with each of the one or more remote devices to the transformed data sample to detect the sub-carrier symbol for that device. The at least one demodulated wideband signal pulse may be a plurality of wideband symbol pulses such as the wideband symbol pulses associated with an OFDM signal, e.g., 128 wideband symbol pulses.

At block 710, the demapper 306 generates source data responsive to the one or more data symbols. In an exemplary embodiment, the source data is generated from the data symbols by reversing the BPSK, QPSK, QAM, or other such modulation scheme used by the mapper 204. At block 712, the descrambler 308 reverses the scrambling operation introduced by the scrambler 202 to derive the original source data.

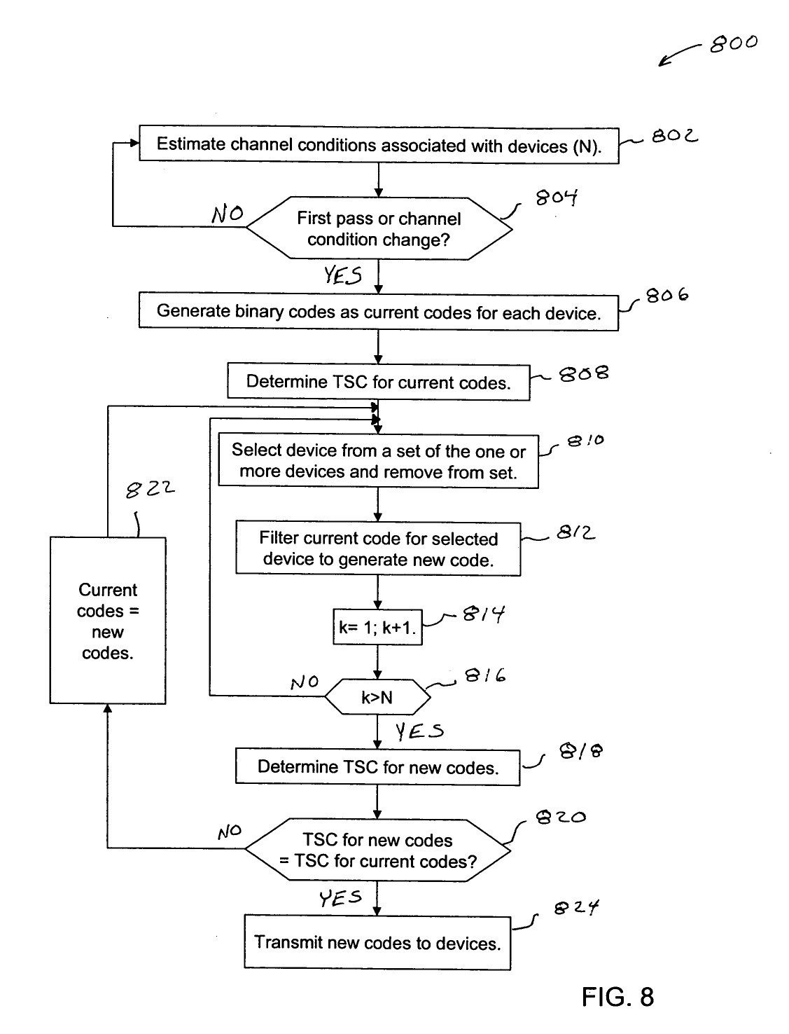

FIG. 8 depicts a flow chart 800 of exemplary steps for generating codes to encode sub-carrier symbols of one or more remote devices over a plurality of communication slots in a wideband communication system. At block 802, the channel estimator 504 estimates channel condition associated with each channel of each remote device. A channel is a particular frequency band of a sub-carrier within a communication slot. Thus, if each communication slot receives an OFDM symbol including 128 sub-carriers, there are at least 128 channels within that communication slot.

At block 804, a decision is made to determine if this is a first pass through the logic or if channel conditions have changed. If this is a first pass through the logic, codes are initially generated for use by the remote devices to encode the sub-carrier symbols. If channel conditions have changed, e.g., due to the addition or removal of a remote device, new codes are generated to replace existing codes in the remote devices in order to optimize communications.

At block 806, the random binary code generator 502 generates binary codes as current codes associated with the remote devices for processing. The binary codes include a digit for each communication slot of the wideband communication system. Specifically, if there are nine communication slots, the binary code will be nine digits long. The random binary code generator 502 may generate a binary code in response to a signal generated by the channel estimator 504, e.g., if the estimated channels are outside of a predefined range.

At block 808, the TSC 508 generates a correlation value for the current codes. In an exemplary embodiment the correlation value is a total squared correlation value.

At block 810, the code generation unit 414 selects a particular remote device from a set of the one or more remote devices, e.g., a set of N devices. In an exemplary embodiment, the remote device may be selected based on the effectiveness of the filter 506 in generating the least TSC value using the current codes associated with that device. In an alternative exemplary embodiment, the remote device may be selected arbitrarily, randomly, or pseudo-randomly.

At block 812, the current code associated with the device selected at block 810 is filtered using the filter 506 to generate a new code for that device. An exemplary filter 506 is described in greater detail below.

At block 814, a counter for the number of devices is incremented. The first pass through block 814, the counter, k, is set to one. Thereafter, it is incremented by one for each pass.

At block 814, a decision is made regarding the value of the counter. If the counter, k, is less than or equal to N, i.e., the total number of devices,(indicating that all devices have not been processed) processing resumes at block 810 with another device being selected from the remaining group of devices that have not been processed. If the counter, k, is greater than N (indicating that all devices have been selected and processed) processing proceeds at block 818.

At block 818, a correlation value, e.g., a TSC value, is determined for the new codes generated by the filter 506. At block 820, the correlation value of the new codes is compared to the correlation value of the current codes. If the correlation values are approximately equal, processing proceeds to block 824 with the new codes being transmitted to the respective devices. In the correlation values are unequal, the current codes are set to equal the new codes and the steps of blocks 810-820 are repeated in an iterative fashion until the new and current correlation values are at least approximately equal.

Additional implementation details are now provided for the exemplary communication system 100 described above with reference to FIGS. 1, 2, and 3. In order to enhance user capacity, a synchronous OFDM system with multiple codes assigned per piconet/user is provided in accordance with the present invention. Such a network scales the number of users while keeping the interference under control and maintaining high data transfer rates. An architecture encompassing a central controller for coordinating communication is provided. The exemplary communication system 100 offers flexibility in assigning codes corresponding to each OFDM sub-carrier frequency depending upon the extent of flat fading. In other words, channels experiencing deep fades are assigned codes to overcome the fading effect. An uplink between the remote devices and the central controller is described below.

A symbol synchronous multiband OFDM system with K users is considered. Let T, be the duration of each OFDM symbol transmitted. The symbols are transmitted in both time and frequency slots as described above with reference to TABLE 1. The symbol power in each of the slots is multiplied by certain factors, which in totality, over all the frequency time slots, forms a code. In other words, each of these coded symbols, transmitted in different slots, is collected at a receiver and decoded to obtain the actual symbol transmitted. Such a code, spread in frequency and time is used to distinguish between different users.

Let sⱼ(t) be the OFDM symbol transmitted by the j^{th} user ∀ t ε (0,T). Let the multipath channel h(t) be confined to finite interval[0,T_{b}]. Let the sequence h₀h₁ . . . hᵤ denote the base band equivalent impulse response of the channel sampled at the rate 1/Tₛ, with the communication slot time period, T_{b}, calculated in accordance with equation 1:
T_{b}=(1+v)Tₛ (1)
where v equals the number of communication slots.

To continue with the discrete description of the system, let sⱼ[n]=sⱼ(nTₛ) and wⱼ[n]=wⱼ(nTₛ) denote samples of transmitted symbol and the sample of channel noise for the j^{th} user, respectively. To overcome the effect of intersymbol interference, a cyclically extended guard interval is created to convert the linear convolution of symbols and channels into a circular convolution. Let the code for the j^{th} user that is used to hide these symbols from others be cⱼ. With everything in place, including the cyclic prefix, the matrix description of the channel as seen by the j^{th} user is calculated using equation 2:
Yⱼ=Hⱼcⱼsⱼ (2)
where Hⱼ is calculated using equation 3:
Hⱼ=[Hⱼ₁ Hⱼ₂ . . . H_{jN}_{ᵥ}] ∀Nᵥ=N_{f}Nₜ (3)
where N_{f} is the number of frequency slots and Nₜ is the number of time slots.

Hⱼₖ is then represented by expression 4:

$${H}_{jk} = [ \begin{matrix}{h}_{j 0}^{k} & {h}_{j 1}^{k} & {h}_{jl}^{k} & ⋯ & {h}_{jv}^{k} & 0 & ⋯ & 0 \\ 0 & {h}_{j 0}^{k} & {h}_{j 1}^{k} & ⋯ & {h}_{j ( v - 1 )}^{k} & {h}_{jv}^{k} & ⋯ & 0 \\ ⋮ & ⋮ & ⋮ & & ⋮ & ⋮ & & ⋮ \\ {h}_{j 1}^{k} & {h}_{j 2}^{k} & {h}_{j 3}^{k} & ⋯ & {h}_{jv}^{k} & 0 & ⋯ & {h}_{j 0}^{k}\end{matrix} ] \qquad ( 4 )$$

where hⱼₗ^{k} is the l^{th} channel sample in the k^{th} slot of the j^{th} user.

The initial code vector spanning the entire time-frequency space for a single symbol is calculated using equation 5:
cⱼ=[cⱼ₁ cⱼ₂ . . . c_{jN}_{ᵥ}]^{T} (5)
cⱼₖ=αⱼₖIₙ ∀αⱼ^{t}αⱼ=1 (6)
where the symbol sⱼ may be represented as shown in equation 7:
sⱼ=[s(N−1)s(N−2) . . . s(0)]^{T}×1_{N}_{ᵥ} (7)

Therefore, the transmitted symbol can be written as shown in equation 8:

$${y}_{j} = ( {\sum }_{k} {H}_{jk} {c}_{jk} ) {s}_{j} \qquad ( 8 )$$

If X is the received signal, then X can be represented as show in equation 9:

$$x = {\sum }_{j = 1}^{K} {y}_{j} + w \qquad ( 9 )$$

The discrete Fourier transform of N-by-1 vector X is defined by the N-by-1 vector shown in expression 10:
X=[X[N−1],X[N−2], . . . X [0]] (10)
where, as shown in equation 11,

$$X ( k ) = \frac{1}{\sqrt{N}} {\sum }_{n = 0}^{N - 1} x [ n ] exp ( - j \frac{2 π}{N} kn ) , k = 0 , 1 , … , N - 1 \qquad ( 11 )$$

The exponential term in equation 1 is referred to as a kernel of a DFT. Correspondingly, the inverse discrete Fourier transform (IDFT) of the N-by-1 vector X is defined by equation 12 as:

$$x [ n ] = \frac{1}{\sqrt{N}} {\sum }_{k = 0}^{N - 1} X [ k ] exp ( j \frac{2 π}{N} kn ) , n = 0 , 1 , … , N - 1 \qquad ( 12 )$$

An important property of the circulant matrix exemplified by the channel matrix, Hⱼₖ, is that it permits spectral decomposition as shown in equation 13:
Hⱼₖ=Q^{H}ΛⱼₖQ (13)
where the superscript H stands for Hermitian transpose. The matrix Q is a square matrix defined in terms of a kernel of N-point DFT as shown in equation 14:

$$Q = [ \begin{matrix}exp ( - j \frac{2 π}{N} ( N - 1 ) ( N - 1 ) ) & ⋯ & exp ( - j \frac{2 π}{N} 2 ( N - 1 ) ) & exp ( - j \frac{2 π}{N} ( N - 1 ) ) & 1 \\ exp ( - j \frac{2 π}{N} ( N - 1 ) ( N - 2 ) ) & ⋯ & exp ( - j \frac{2 π}{N} 2 ( N - 2 ) ) & exp ( - j \frac{2 π}{N} ( N - 2 ) ) & 1 \\ ⋮ & & ⋮ & ⋮ & ⋮ \\ exp ( - j \frac{2 π}{N} ( N - 1 ) ) & ⋯ & exp ( - j \frac{2 π}{N} 2 ) & exp ( - j \frac{2 π}{N} ) & 1 \\ 1 & & 1 & 1 & 1\end{matrix} ] \qquad ( 14 )$$

From the above it is clear that the k^{th} element of the N-by-N matrix, Q, starting from the bottom right at k=0 and l=0 and counting up step by step is as shown in equation 15:

$${q}_{kl} = \frac{1}{\sqrt{N}} exp ( - j \frac{2 π}{N} kl ) , ( k , l ) = 0 , 1 , … , N - 1 \qquad ( 15 )$$

The matrix Q is a unitary matrix such as shown in equation 16:
Q^{H}Q=I (16)
where I is the identity matrix.

The matrix Λⱼₖ, shown in equation 17, is a diagonal matrix that contains the N discrete Fourier transform values of the sequences h₀h₁ . . . hᵤ characterizing the channel.

$${Λ}_{jk} = [ \begin{matrix}{λ}_{jN - 1}^{k} & 0 & ⋯ & 0 \\ 0 & {λ}_{jN - 2}^{k} & ⋯ & 0 \\ ⋮ & ⋮ & & ⋮ \\ 0 & 0 & & {λ}_{j 0}^{k}\end{matrix} ] \qquad ( 17 )$$

When a receiver receives the transmitted signal, the modulated passband data is converted into baseband by process of demodulation. The transmitted symbols pass through a DFT block after having removed the cyclic prefix and hence the effect of multipath. Using the orthonormal matrix Q for recovering the original data shows the demodulation process. If the received signal vector is X then, X, is as shown in equation 18:
X=Qx (18)

Equation 19 is derived from equations 9 and 18:

$$X = Q ( {\sum }_{j = 1}^{K} {y}_{j} + w ) \qquad ( 19 )$$

It is known from equations 2 and 8 that:

$${y}_{j} = {H}_{j} {c}_{j} {s}_{j} = ( {\sum }_{k = 1}^{{N}_{v}} {H}_{jk} {c}_{jk} ) {s}_{j}$$

Substituting this expression into equation 19 yields:

$$X = Q ( {\sum }_{j = 1}^{K} ( {\sum }_{k = 1}^{{N}_{v}} {H}_{jk} {c}_{jk} ) {s}_{j} + w )$$

which simplifies to equation 20:

$$x = {\sum }_{j = 1}^{K} {\sum }_{k = 1}^{{N}_{v}} {QH}_{jk} {c}_{jk} {s}_{j} + Qw \qquad ( 20 )$$

Using equations 6 and 13 in equation 20 yields equation 21:

$$X = {\sum }_{j = 1}^{K} {\sum }_{k = 1}^{{N}_{v}} {QQ}^{H} {Λ}_{jk} Q {α}_{jk} {I}_{N} {s}_{j} + Qw \qquad ( 21 )$$

which yields equation 22:

$$X = {\sum }_{j = 1}^{K} {\sum }_{k = 1}^{{N}_{v}} {α}_{jk} {Λ}_{jk} {S}_{j} + W \\ where {S}_{j} = {Qs}_{j} \qquad ( 22 )$$

Equation 22 is then decomposed into its constituent elements as shown in equation 23:

$$X [ p ] = {\sum }_{j = 1}^{K} {\sum }_{k = 1}^{{N}_{v}} {α}_{jk} {λ}_{jp}^{k} {S}_{j} [ p ] + W [ p ] p = 0 , 1 , … , N - 1 \qquad ( 23 )$$

If the number of users/piconets K>Nᵥ, then the system is considered to be overloaded. On the other hand if K<Nᵥ then the system is underloaded. In an overloaded system, transmissions cease to be orthogonal. As will be shown below, the central controller, which aids in co-ordination and synchronization along with other operations, also helps in decoding the sent data and transmitting it to its final destination. The central controller is therefore modeled along the same lines as the base unit of a cordless phone. In an exemplary embodiment, for decoding purposes, the final code matrix containing the code of each device in the system is placed on the central controller overlooking the communication in the Personal Area Network (PAN). By shifting the brunt of computation onto the central controller, the design of mobile and other communicating devices for such a short range wireless communication can be kept simple. In an exemplary embodiment, the central controller is a “master” and the remote devices are “slaves.”

A lower bound for maximum correlation among K users having unit energy sequences is set forth in equation 24:

$${\sum }_{i = 1}^{K} {\sum }_{j = 1}^{K} {( {β}_{i}^{T} {β}_{j} )}^{2} \geq \frac{{K}^{2}}{{N}_{v}} \qquad ( 24 )$$

The left hand side in the above expression is commonly referred to as Total Squared Correlation (TSC). When K<Nᵥ then TSC=K, which is achieved by K orthonormal vectors. On the other hand, when K>Nᵥ, the lower bound can be achieved. The set of signature sequences meeting the lower bound satisfy the properties shown in equations 25 and 26:

$$\begin{matrix}{β}^{T} β = \frac{K}{{N}_{v}} {I}_{{N}_{v}} for the case when K > {N}_{v} & ( 25 ) \\ {β}^{T} β = {I}_{K} , for the case when K < {N}_{v} & ( 26 )\end{matrix}$$

The number of users that can be admitted into this overloaded system, however, is upper bounded in accordance with equation 27:
K<Nᵥ(1+1/μ) (27)
where μ is the signal-to-interference (SIR) threshold. The Mean Square Error (MSE) in the system relates to TSC. Assume that βᵢ,i=1, . . . ,K, are the signature sequences of the users. Also, assume that the signals are received at the central controller with all signal processing capabilities (similar to base station in cellular network) by matched filters, and transmitted power for all users is assumed to be the same, i.e., pᵢ=p. If the received signal is r then the MSE for the i^{th} user is as shown in equations 28 and 29:

$$\begin{matrix}{MSE}_{i} = E [ {( {r}^{T} {β}_{i} - {s}_{i} )}^{2} ] & ( 28 ) \\ = {β}_{i}^{T} ( p {\sum }_{j = 1}^{K} {β}_{j} {β}_{j}^{T} + {σ}^{2} {I}_{{N}_{v}} ) {β}_{i} - 2 \sqrt{p} {β}_{i}^{T} {β}_{i} + 1 & ( 29 )\end{matrix}$$

The total MSE in the system is as shown in equations 30 and 31:

$$\begin{matrix}MSE = {\sum }_{i = 1}^{K} {MSE}_{i} & ( 30 ) \\ = p {\sum }_{i = 1}^{K} {\sum }_{j = 1}^{K} {( {β}_{i}^{T} {β}_{j} )}^{2} - ( 2 \sqrt{p} - {σ}^{2} ) {\sum }_{i = 1}^{K} {β}_{i}^{T} {β}_{i} + K & ( 31 )\end{matrix}$$

Observing that the first term in equation 30 is the TSC from equation 24 and making use of the fact that the signature sequences are unit energy vectors, equation 32 shows direct relationship between MSE and TSC:
MSE=pTSC+(1+σ²−2\sqrt{p})K (32)

Therefore the MSE of the system can be decreased by correspondingly reducing the TSC as shown in equation 33:

$$TSC = {( {β}_{k}^{T} {β}_{k} )}^{2} + 2 {β}_{k}^{T} ( {\sum }_{j \neq k} {β}_{j} {β}_{j}^{T} ) {β}_{k} + {γ}_{k} \qquad ( 33 )$$

where, as shown in equation 34,

$${γ}_{k} = {\sum }_{i \neq k} {\sum }_{j \neq k} {( {β}_{i}^{T} {β}_{j} )}^{2} \qquad ( 34 )$$

Since all signature sequences are assumed to be unit energy vectors, equation 33 reduces to yield equation 35:
TSC=2βₖ^{T}Aₖβₖ+γₖ+1−2σ² (35)
where, as shown in equation 36,

$${A}_{k} = {\sum }_{j \neq k} {β}_{j} {β}_{j}^{T} + {σ}^{2} {I}_{{N}_{v}} \qquad ( 36 )$$

If the k^{th} user's sequence is replaced in accordance with equation 37:

$${c}_{k} = \frac{{A}_{k}^{- 1} {β}_{k}}{{( {β}_{k}^{T} {A}_{k}^{- 2} {β}_{k} )}^{1 / 2}} where {c}_{k}^{T} {c}_{k} = {β}_{k}^{T} {β}_{k} = 1 \qquad ( 37 )$$

and the new set of sequences is given by equation 38:
\overline{β}=[β₁ . . . βₖ₋₁ cₖ βₖ₊₁ . . . β_{K}] (38)
cₖ is a normalized MMSE filter for user k. The MMSE filter can be regarded as a special matched filter holding lower cross correlation with signature sequences of different users. The revised TSC is as shown in equation 39:

$${TSC}_{new} = \frac{2 {β}_{k}^{T} {A}_{k}^{- 1} {β}_{k}}{{β}_{k}^{T} {A}_{k}^{- 2} {β}_{k}} + {γ}_{k} + 1 - 2 {σ}^{2} \\ {TSC}_{new} \leq {TSC}_{old} where equality holds when {c}_{k} = {β}_{k} . \qquad ( 39 )$$

Based on the above equation, an iterative algorithm whereby each user updates its sequence in a sequential manner until/unless no further reduction in TSC is possible, i.e., the algorithm converges.

The iterative procedure begins with K unit length vectors randomly selected, e.g., β(0)=[β₁(0), . . . β_{K}(0)]. After n iterations, the composite set of sequences is β(n)=[β₁(n), . . . ,β_{K}(n)]. In intermediate stages, e.g., at the k−1^{th} stage of the n+1^{th} iteration, the signature set will be as shown in equation 40:
βₖ₋₁(n+1)=[β₁(n+1), . . . ,βₖ₋₁(n+1) βₖ(n) . . . β_{K}(n)] (40)

Correspondingly, the signature sequence, βₖ is updated using the matrix shown in equation 41:

$${A}_{k} ( n + 1 ) = {\sum }_{j < k} {β}_{j} ( n + 1 ) {β}_{j}^{T} ( n + 1 ) + {\sum }_{j > k} {β}_{j} ( n ) {β}_{j}^{T} ( n ) + {σ}^{2} {I}_{{N}_{v}} \qquad ( 41 )$$

while updates are according to equation 42:

$${β}_{k} ( n + 1 ) = \frac{{{A}_{k} ( n + 1 )}^{- 1} {β}_{k} ( n )}{{( {β}_{k}^{T} ( n ) {{A}_{k} ( n + 1 )}^{- 2} {β}_{k} )}^{1 / 2}} \qquad ( 42 )$$

such that a vector set in accordance with equation 43 is yielded
βk(n+1)=[β₁(n+1), . . . βₖ₋₁(n+1) βₖ(n+1), . . . β_{K}(n)] (43)

Since each update decreases the TSC, TSCₖ₊₁(n)≦TSCₖ(n) and after the entire set of sequences has been updated recursively, TSC(n+1)≦TSC (n).

The fixed point denoted by the code vectors of each user is obtained when the iteratively determined code matrix converges, which in turn occurs when each code vector becomes the eigenvector of the correlation matrix in accordance with equation 44:
Aₖ⁻¹βₖ=φₖβₖ (44)
where φₖ is the eigenvalue of matrix Aₖ⁻¹.

The iterative algorithm is now described for a synchronous Multiband-OFDM system. Recalling equation 23, a system can strive for optimality by using the iterative algorithm and simultaneously updating each sequence corresponding to the seemingly independent parallel channels in an equally independent fashion. Therefore, there will be N-simultaneous systems which will undergo iterative updates based on TSC reduction at each stage.

$$X [ p ] = {\sum }_{j = 1}^{K} {\sum }_{k = 1}^{{N}_{v}} {α}_{jk} {λ}_{jp}^{k} {S}_{j} [ p ] + W [ p ]$$

$$p = 0 , 1 , … , N - 1$$

Placing βⱼₖ^{p}=αⱼₖ λⱼₚ^{k} in the above expression yields equation 45:

$$X [ p ] = {\sum }_{j = 1}^{K} {\sum }_{k = 1}^{{N}_{v}} {β}_{jk}^{p} {S}_{j} [ p ] + W [ p ] \qquad ( 45 )$$

Therefore, code sequence for the p^{th} data channel corresponding to the j^{th} user will be as shown in equation 46:
βⱼ^{p}=[βⱼ₁^{p}, . . . ,β_{jN}_{ᵥ}^{p}] (46)

Each of these βⱼ^{p} for each of the K users and each of the N-channels is optimized to achieve the lowest TSC, which is lower bounded by equation 24. Although convergence always exists, there also may exist a suboptimal solution of the fixed points, (i.e., the final signature set of each user). If the initial sequence is randomly chosen then the simulations show always a convergence to the optimal set of fixed points. If the sequences are completely randomly chosen, then the choice of update, i.e., at a given time which one of the users whose sequence remains to be updated, is updated would affect the convergence.

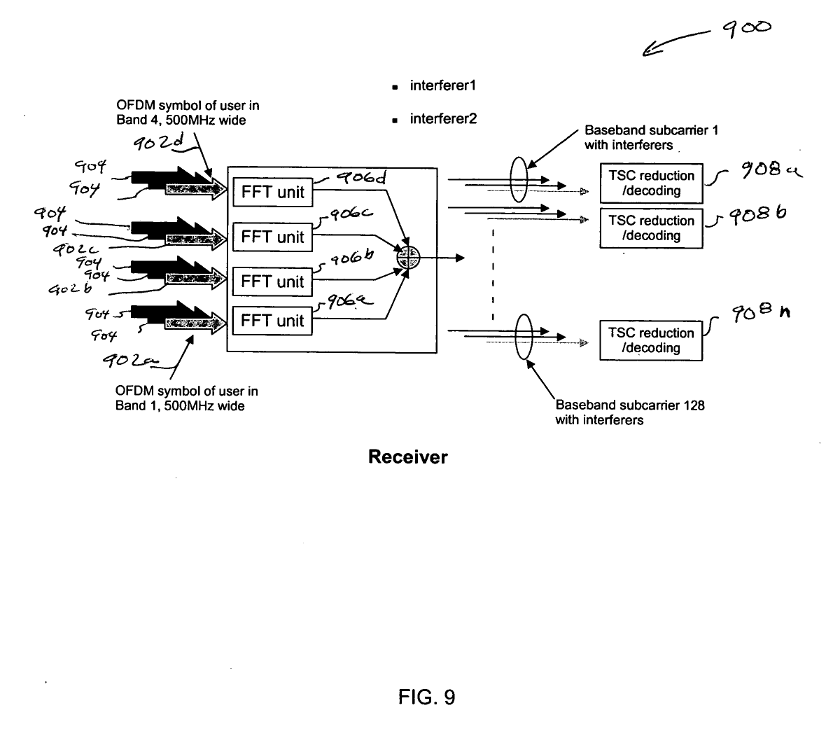

FIG. 9 shows a simplified receiver structure 900 for use in the central controller. An incoming signal 902 is modulated to occupy different bands contains interfering signals of other users (channels) 904. This signal is fed to an FFT block 906 which performs an FFT operation. The output signal of the receiver contains 128 base band sub-carrier signals that are to be treated independently. Initially, the receiver generates ad hoc codes through TSC reduction mechanism 908, which are fed back to the transmitters in the remote devices.

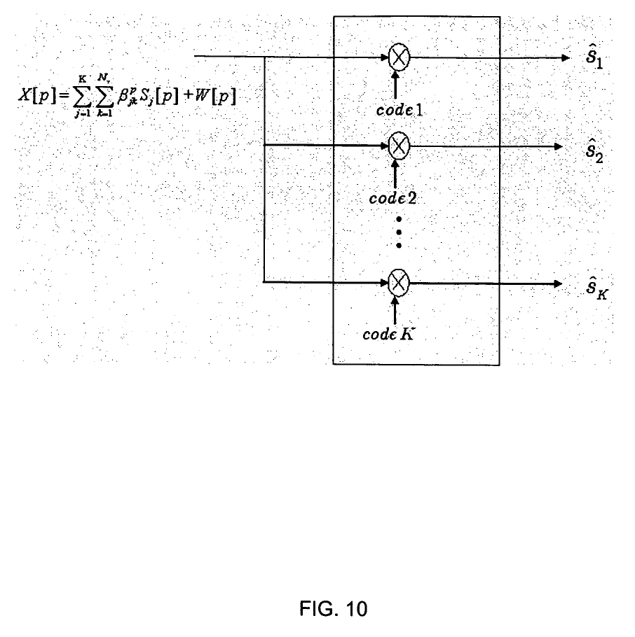

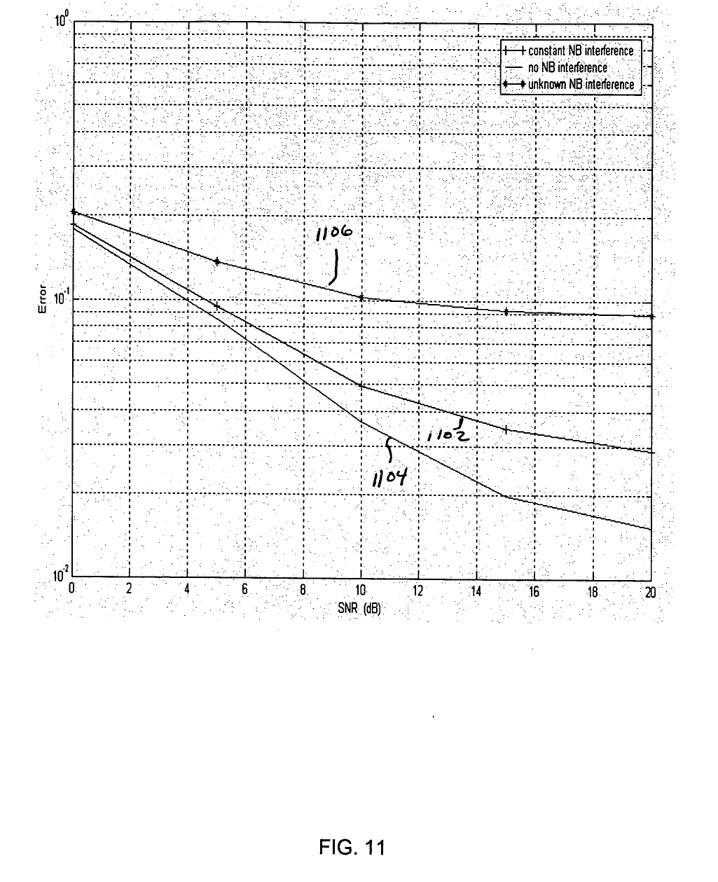

FIG. 10 illustrates receiver operation once the codes have been generated and assigned to the users. A simple decoding scheme is employed whereby the received signal is multiplied by the respective codes of the devices which are in essence performing the MMSE operation of equation 44.

Updating the device whose update results in greater reduction of TSC should lead to faster convergence towards the lower bound in equation 24. Therefore, the device to be updated should be chosen according to minimum TSC, as illustrated by expressions 47 and 48:

$$\begin{matrix}min TSC & ( 47 ) \\ ⇒ min ( 2 \frac{{β}_{k}^{T} {A}_{k}^{- 1} {β}_{k}}{{β}_{k}^{T} {A}_{k}^{- 2} {β}_{k}} + {γ}_{k} ) & ( 48 )\end{matrix}$$

Therefore, user k will be updated before remaining users provided, as shown in equation 49:

$$2 \frac{{β}_{k}^{T} {A}_{k}^{- 1} {β}_{k}}{{β}_{k}^{T} {A}_{k}^{- 2} {β}_{k}} + {γ}_{k} \leq 2 \frac{{β}_{j}^{T} {A}_{j}^{- 1} {β}_{j}}{{β}_{j}^{T} {A}_{j}^{- 2} {β}_{j}} + {γ}_{j} \begin{matrix}( j , k ) ∈ ( \overline{K} , … , K ) \\ ∀ j ∈ ( \overline{K} , … , K )\end{matrix} \qquad ( 49 )$$

where \overline{K}−1 are the number of users already updated.

Simplifying equation 46 using linear algebra yields equation 50,

$$min ( ( \frac{{β}_{k}^{T} {A}_{k}^{- 1} {β}_{k}}{{β}_{k}^{T} {A}_{k}^{- 2} {β}_{k}} ) - {\sum }_{j \neq k} {( {β}_{j}^{T} {β}_{k} )}^{2} ) ∀ k ∈ ( \overline{K} , … , K ) \qquad ( 50 )$$

The signal adaptation algorithms operate slowly as compared to those for multi-user interference suppression. Therefore, such a procedure is appropriate for a stable channel, which for the case of an indoor channel is a reasonable assumption.

The computations are assumed to be performed by a central controller which aids in co-ordination and overseeing the communication process involving synchronization, channel estimations, code generation, code assignment and power transmission control (e.g., within FCC regulation).

One of the key features of UWB, is that it does not cause unnecessary interference to the existing narrowband (NB) technologies present in certain portions of the operational bandwidth. The FCC imposed power constraints to check the interference from UWB to NB systems. Interference from the NB on UWB systems, however, is potentially problematic. The interference due to narrowband systems on the UWB can be overwhelming. First, the total power of a NB transmission generally will fall within the UWB passband. Second, a wide UWB passband (several hundred MHz or more) may span multiple NB transmitters, some of which may be very powerful and/or very near to the UWB receiver. This was one of the reasons which led to single band UWB giving way to a multiband approach in which the UWB's 7.5 GHz band is split into 14 multibands spanning 528 MHz each. This meant that a band having tremendous presence of narrowband systems could be shut off, thereby eliminating interference.

The multiband approach, however, does not completely solve the problem at hand. The multibands themselves span hundreds of MHz and pose similar problem as its parent single band approach. The combination of multiband with OFDM aims to effectively handle the multipath as well as narrowband interference issues. With OFDM splitting the broad frequency selective channel into several narrowband frequency flat channels, the NB interference would now affect the tones (approx. 4 MHz wide) and hence the data carried by those tones. The narrowband interference would therefore affect some of the tones thereby rendering the information on these tones unreliable. One can then employ error correction techniques to recover the lost data. The system proposed in the previous section is considered and its behavior is analyzed in the presence of narrowband interference. It will be shown that the system adapts well to such interference and can be further improved when error correction techniques are incorporated.

There are primarily two types of interference considered here:
(i) Constant interference: Such interference may be present within a narrowband at all times. It could be due to microwave devices which are on for large chunk of time. Such interference can be known precisely at the central controller.
(ii) Narrowband Interference: Interference due to other narrowband technologies like 802.11a etc. of which only the amount of power put out within the band can be known.
(iii) The approach for handling the two types of interference defined above is different. Constant interference is considered first. As mentioned above, the constant interference can be known precisely at the central receiver. Assume the presence of constant interference in one of the tones. The received signal at the central controller in the presence of a constant interference in one of the tones, say l^{th} tone, is given by equation 51:

$$X [ l ] = {\sum }_{j = 1}^{K} {\sum }_{k = 1}^{{N}_{v}} {β}_{jk}^{l} {S}_{j} [ l ] + W [ l ] + I \qquad ( 51 )$$

where I represents the interference. Assuming this interference is known precisely at the receiver since it is constant, it can be treated as another virtual user/device in the system with a different amount of power. As a result, the number of users in such a system is K+1. Dropping the subscript l, replacing the summation in equation 51 by the vector product, and applying equation 29, the minimum square error (MSE) for the i^{th} user is given by equation 52:

$${MSE}_{i} = {β}_{i}^{T} ( p {\sum }_{j = 1}^{K} {β}_{j} {β}_{j}^{T} + {p}_{K + 1} {β}_{K + 1} {β}_{K + 1}^{T} + {σ}^{2} {I}_{{N}_{v}} ) {β}_{i} - 2 \sqrt{p} {β}_{i}^{T} {β}_{i} + 1 \qquad ( 52 )$$

where, interference I is represented by a code vector β_{K+1} and p_{K+1} is the interference power. The total MSE of the system is then given by equation 53:

$$\begin{matrix}MSE = {\sum }_{i = 1}^{K} {MSE}_{i} \\ = p {\sum }_{i = 1}^{K} {\sum }_{j = 1}^{K} {( {β}_{i}^{T} {β}_{j} )}^{2} + {p}_{K + 1} {\sum }_{i = 1}^{K} {( {β}_{i}^{T} {β}_{K + 1} )}^{2} - \\ ( 2 \sqrt{p} - {σ}^{2} ) {\sum }_{i = 1}^{K} {β}_{i}^{T} {β}_{i} + K\end{matrix} \qquad ( 53 )$$

Representing the total MSE in terms of Total Squared Correlation similar to the expression in equation 32, the total MSE can be determined in accordance with equation 54:
MSE=pTSC+(1+σ²−2\sqrt{p})K (54)
Therefore, TSC can be calculated in accordance with equation 55:

$$\begin{matrix}TSC = {\sum }_{i = 1}^{K} {\sum }_{j = 1}^{K} {( {β}_{i}^{T} {β}_{j} )}^{2} + \frac{{p}_{K + 1}}{p} {\sum }_{i = 1}^{K} {( {β}_{i}^{T} {β}_{K + 1} )}^{2} \\ = {( {β}_{m}^{T} {β}_{m} )}^{2} + 2 {β}_{m}^{T} ( {\sum }_{j \neq m} {β}_{j} {β}_{j}^{T} ) {β}_{m} + \\ \frac{{p}_{K + 1}}{p} {β}_{m}^{T} ( {β}_{K + 1} {β}_{K + 1}^{T} ) {β}_{m} + {γ}_{m}\end{matrix} \qquad ( 55 )$$

where γₘ is the same as defined in equation 34. Equation 55 shows the role of each user, in this case the m^{th} user, in the TSC. Finally, the TSC can be calculated using equation 56:
TSC=2βₘ^{T}Aₘβₘ+γₘ+1−2σ² (56)
where Aₘ is determined according to equation 57:

$${A}_{m} = {\sum }_{j \neq k} {β}_{j} {β}_{j}^{T} + \frac{{p}_{K + 1}}{2 p} ( {β}_{K + 1} {β}_{K + 1}^{T} ) + {σ}^{2} {I}_{{N}_{v}} \qquad ( 57 )$$

The expression for TSC with constant interference is similar to that obtained without any narrowband interference. Consequently, the same iterative procedure for reduction of TSC is followed until it converges. The codes therefore adapt in such an interfering environment thereby providing extra protection against interference.

In the case of narrowband (NB) interference, where the exact signal may not be known precisely, but for the actual power in the interfering band, one can easily deduce equation 58 for TSC as set forth below:
TSC=2βₘ^{T}Aₘβₘ+γₘ+1−2σ² (58)
where

$${A}_{m} = {\sum }_{j \neq k} {β}_{j} {β}_{j}^{T} + {σ}^{2} {I}_{{N}_{v}} + {σ}_{I}^{2} {G}_{{N}_{v}} , {σ}_{I}^{2}$$

is the interference power, and G_{N}_{ᵥ} is a square matrix (Nᵥ×Nᵥ) with diagonal elements showing the presence of interference in different time frequency slots. In a worst case scenario, if the interference is present in all time frequency slots then G_{N}_{ᵥ}=I_{N}_{ᵥ},i.e., is an identity matrix.

The effect of NB interference on user capacity of the system is now evaluated. Equation 27 above provided the number of users that can be admitted into the system based on desirable signal to interference ratio (SIR). This expression is a very general expression that does not take any power constraints into consideration. The upper bound on the user capacity with power constraint is now derived. To derive the upper bound on user capacity a single sub-carrier in all the slots is considered.

For the constant interference, which is assumed to be known precisely at the central controller, the interference is treated as a virtual additional user in the system. In such a case, \overline{p} will be modified as

$$\overline{p} = \frac{1}{{N}_{v}} {\sum }_{i = 1}^{K + 1} {p}_{i} ,$$

where, p₁=p₂= . . . =p_{K}=p are the powers associated with each user and p_{K+1} is the constant interference power. As a result, equation 59 is developed:

$$\frac{Kp + {p}_{K + 1}}{{N}_{v}} \geq \frac{( K + 1 ) {μσ}^{2}}{{N}_{v} ( 1 + μ ) - ( K + 1 ) μ} \qquad ( 59 )$$

Equation 59 is a quadratic inequality in K which is the number of users admitted in the system.

As can be easily seen for p_{K+1}=0, the case exists when there is no interference, and the number of users that can be admitted are shown by equation 60:

$$K \leq {N}_{v} ( 1 + \frac{1}{μ} - \frac{{σ}^{2}}{p} ) \qquad ( 60 )$$

The narrowband interference which is not constant is shown by equation 61:

$$K \frac{μ}{1 + μ} \leq {\sum }_{i = 1}^{{N}_{v}} \frac{\overline{p}}{\overline{p} + {σ}_{N}^{2}} \qquad ( 61 )$$

where σ_{N}² is no longer simply Gaussian noise at the receiver but also contains the narrowband noise which could be present in some or all of the frequency time slots.

Therefore, as shown in equation 62:

$$K \frac{μ}{1 + μ} \leq a ( \frac{\overline{p}}{\overline{p} + {σ}^{2}} ) + b ( \frac{\overline{p}}{\overline{p} + {σ}^{2} + {σ}_{NB}^{2}} ) \qquad ( 62 )$$

where a+b=Nᵥ, σ² is power of Gaussian noise, σ_{NB}² is narrowband interference power, present in b slots.

FIG. 11 illustrates the error for the two different types of narrowband interference when the interference exists in all the time frequency slots and SIR is −10 dB, K=11, and N=9. FIG. 11 includes a constant narrowband interference curve 1102, a no narrowband interference curve 1104, and an unknown narrowband interference curve 1106.

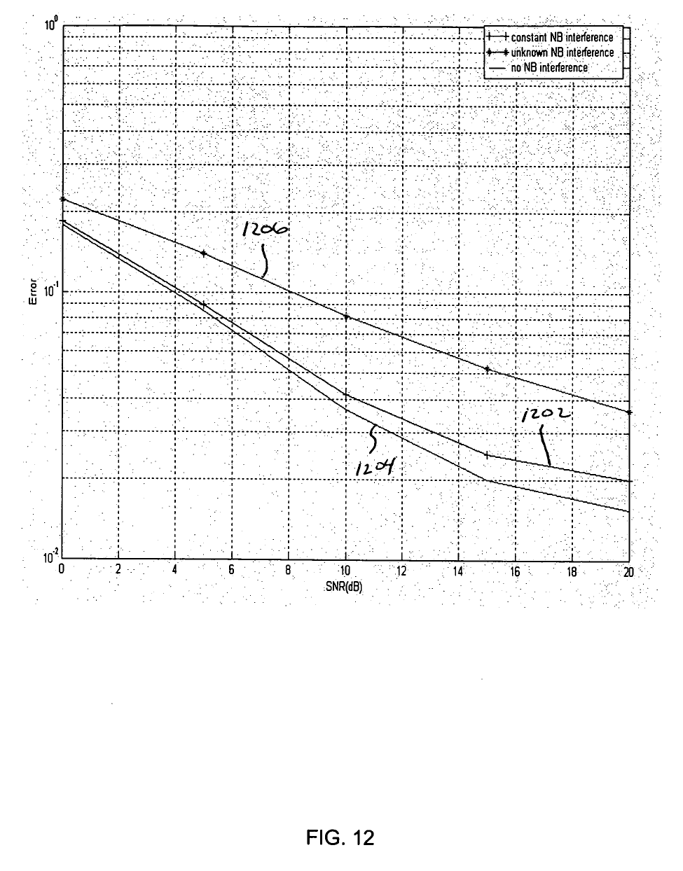

FIG. 12 illustrates the error for the two different types of narrowband interference when the interference exists in a single frequency band and along all time slots. SIR is −10 dB, K=11, and N=9. FIG. 12 includes a constant narrowband interference curve 1202, a no narrowband interference curve 1204, and an unknown narrowband interference curve 1206.

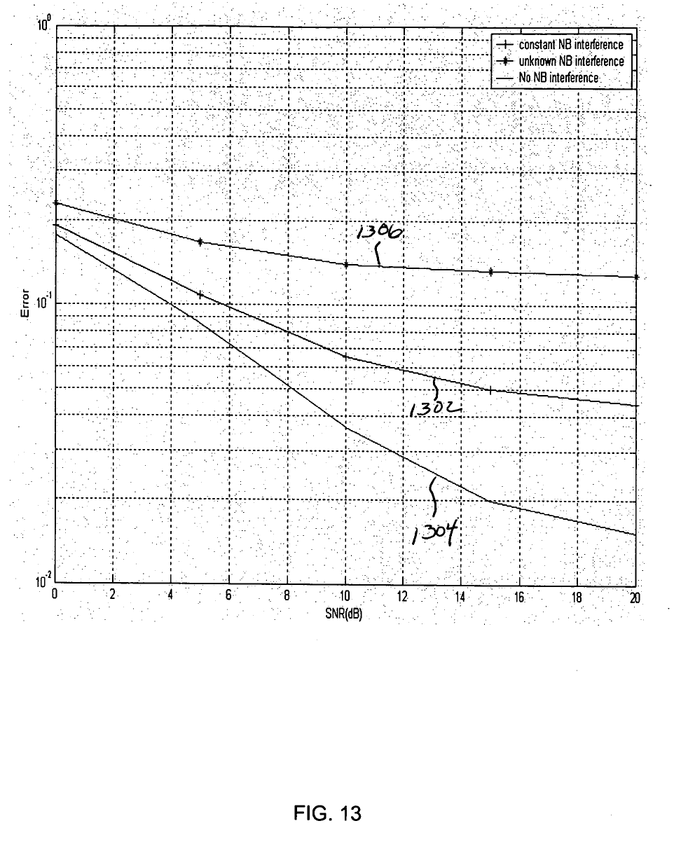

FIG. 13 illustrates the error for the two different types of narrowband interference when the interference exists in all the time frequency slots and SIR is −5 dB, K=11, and N=9. FIG. 13 includes a constant narrowband interference curve 1302, a no narrowband interference curve 1304, and an unknown narrowband interference curve 1306.

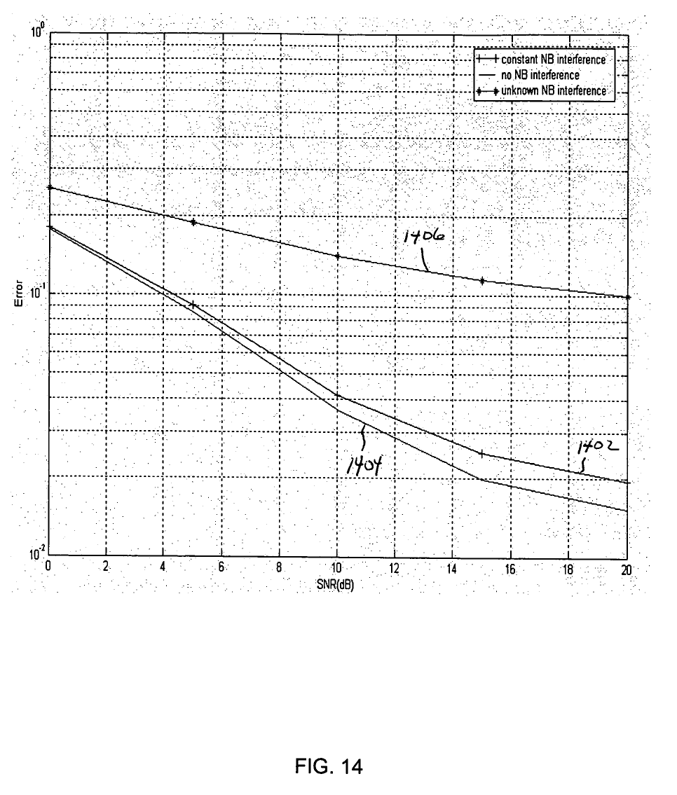

FIG. 14 illustrates the error for the two different types of narrowband interference when the interference exists in a single frequency band and along all time slots. SIR is −5 dB, K=11, and N=9. FIG. 14 includes a constant narrowband interference curve 1402, a no narrowband interference curve 1404, and an unknown narrowband interference curve 1406.

FIGS. 11-14 show that the codes perform reasonably well even in presence of interference. These figures show the performance of the system in the presence of the two types of interferences discussed above for Signal to Interference Ratios of −10 dB and −5 dB. Two scenarios are considered; one, in which the interference is present in all time frequency slots (worst case scenario) and second, in which there is interference in one of the frequency bands at all times. In other words the particular multiband in which narrowband interference is present may not be completely shut down and can operate under a given quality of service. The codes combined with error coding techniques can help improve the performance of the system on a whole and provide resistance to interference.

Evident from the proposed technique as well as the structure of the receiver, a large number of MMSE blocks are required. This can significantly increase computational requirements, primarily due to calculations involving the inverse of large correlation matrix. In order to circumvent this, various techniques have been put forth, most important of which has been the Multi Stage Nested Weiner Filter implementation, which significantly reduces the MMSE computations by obviating the need for calculating an inverse matrix through use of an elegant iterative subspace decomposition technique. An iterative algorithm (i.e., a Lanczos algorithm) is proposed for increasing computational efficiency by simplifying the treatment of a system of linear equations. The algorithm is employed in two different ways for minimizing the Mean Square Error of a system in an iterative fashion to eventually achieve the final code set vector.

In the proposed system technique, a large number of MMSE blocks may be needed. By employing a reduced rank space search filter, there is a further reduction in computations and hence decrease in cost. Reduced rank of subspace for finding the solution to an MMSE problem is of interest in the field of filter theory.

The signature sequences are unit energy vectors as set forth in equation 63:
MSE=pTSC+(1+σ²−2\sqrt{p})K (63)

Equation 63 shows direct relationship between MSE and TSC. It therefore implies that the MSE of the system can be decreased by correspondingly reducing the TSC.

As set forth in equation 64:

$$TSC = {( {s}_{k}^{T} {s}_{k} )}^{2} + 2 {s}_{k}^{T} ( {\sum }_{j \neq k} {s}_{j} {s}_{j}^{T} ) {s}_{k} + {γ}_{k} \qquad ( 64 )$$

where, as shown in equation 65:

$${γ}_{k} = {\sum }_{i \neq k} {\sum }_{j \neq k} {( {s}_{i}^{T} {S}_{j} )}^{2} \qquad ( 65 )$$

Since all signature sequences are assumed to be unit energy vectors, equation 64 reduces to equation 66:
TSC=2sₖ^{T}Aₖsₖ+γₖ+1−2σ² (66)
where, as shown in equation 67:

$${A}_{k} = {\sum }_{j \neq k} {s}_{j} {s}_{j}^{T} + {σ}^{2} {I}_{{N}_{v}} \qquad ( 67 )$$

Two ways of handling the issue of reducing the MMSE of the entire system include targeting the TSC directly or else the MMSE, which is equivalent to solving a Wiener Hopf equation.

The Total Squared Correlation (TSC) can be observed to be in a typical form such that if the signature waveform of the given user is the eigenvector corresponding to the minimum eigenvalue of the correlation matrix then the replacement of the old signature with the new eigenvector of the correlation matrix leads to decrease in TSC value for that particular iteration. This is shown in the following equation:
TSC=2sₖ^{T}Aₖsₖ+γₖ+1−2σ²

Taking the first expression on the right hand side of the above equation, and assuming that the k^{th} user replaces its current signature waveform with some vector z then the resulting difference in TSC is shown in equation 68:
Γ=tr((Aₖ+sₖsₖ^{T})²)−tr((Aₖ+zz^{T})²) (68)
where tr( ) represents the trace of the matrix enclosed within the brackets.

After some algebraic manipulation, it can be shown that Γ≧0 under the following condition:
sₖ^{T}Aₖsₖ+∥sₖ∥₂²≧z^{T}Aₖz+∥z∥₂²
This implies the relationship shown in equation 69:
sₖ^{T}Aₖsₖ≧z^{T}Aₖz (69)
if ∥sₖ∥₂²=∥z∥₂² which is what will be assumed henceforth. If the chosen vector replacement of the present signature is chosen as the eigenvector of the correlation matrix, then, according to the Rayleigh quotient theorem, if z=qᵢ, leads to equation 70:

$${λ}_{i} = \frac{{q}_{i}^{T} {A}_{k} {q}_{i}}{{q}_{i}^{T} {q}_{i}} \qquad ( 70 )$$

where qᵢ is the eigenvector corresponding to the i^{th} eigenvalue λᵢ. If qᵢ^{T}qᵢ=1, which leads to equation 71:
λᵢ=qᵢ^{T}Aₖqᵢ (71)

If the eigenvalue is the minimum eigenvalue of the correlation matrix, then replacing the signature waveform with eigenvector, η, corresponding to this minimum eigenvalue would result in the largest reduction in TSC or in other words the least TSC as set forth in equation 72:

$${λ}_{min} = {η}^{T} {A}_{k} η = {min}_{{s}_{k}} TSC \qquad ( 72 )$$

Therefore, replacing the signature waveform with the eigenvector of the correlation matrix corresponding to the minimum eigenvalue would appear as the best solution to the problem at hand. However, the eigendecomposition of the entire matrix followed by search for the minimum eigenvalue can be computational intensive. Therefore an algorithm needs to be developed that reduces this search for the minimum eigenvalue over the entire subspace spanned by the eigenvectors of the matrix to a reduced subspace would be useful. At the same time the estimation of the minimum eigenvalue has to be good enough to avoid serious errors.

A Lanczos algorithm is an efficient way of handling the problem of reduced subspace search for the extremal eigenvalues of the correlation matrix. The method involves partial tridiagonalizations of the given matrix. Information about the given matrix's extremal eigenvalues tends to emerge long before tridiagonalization is complete which describes its usefulness when only the largest or smallest eigenvalues are desired.

A derivation of a Lanczos algorithm begins with considering the optimization of Rayleigh quotient as set forth in equation 73:

$$r ( y ) = \frac{{y}^{T} {A}_{k} y}{{y}^{T} y} y \neq 0 \qquad ( 73 )$$

Replacing the correlation matrix Aₖ in equation 73 by a matrix A in general. From the minmax theorem it is known that the minimum and maximum values of r(y) are minimum eigenvalue λₘᵢₙ, and maximum eigenvalue λₘₐₓ of the matrix respectively. Suppose {uᵢ}⊂Rⁿ is a sequence of orthonormal vectors and define the scalars as shown in equation 73:

$${M}_{k} = {λ}_{max} ( {U}_{k}^{T} {AU}_{k} ) = {max}_{y \neq 0} \frac{{y}^{T} ( {U}_{k}^{T} {AU}_{k} ) y}{{y}^{T} y} = {max}_{y \neq 0} r ( {U}_{k} y ) \leq {λ}_{max} ( A ) \\ {m}_{k} = {λ}_{min} ( {U}_{k}^{T} {AU}_{k} ) = {min}_{y \neq 0} \frac{{y}^{T} ( {U}_{k}^{T} {AU}_{k} ) y}{{y}^{T} y} = {min}_{y \neq 0} r ( {U}_{k} y ) \geq {λ}_{min} ( A ) \qquad ( 73 )$$

where Uₖ=[u₁, . . . uₖ]. The Lanczos algorithm can be derived by considering how to generate the uₖ so that Mₖ and mₖ are increasingly better estimates of λₘₐₓ and λₘᵢₙ.

The above requirements can both be satisfied simultaneously as shown in equation 74:
K(A,u₁,k)=span{u₁,Au₁ . . . , A^{k-1}u₁} (74)
which is the range space as shown in equation 75:
K(A,u₁,k)=[u₁,Auᵢ, . . . A^{k-1}u₁] (75)

One can resort to directly computing the elements of tridiagonal matrixT=U^{T}AU. Setting U=[u₁, . . . uₙ], equation 76 can be obtained:

$$T = [ \begin{matrix}{α}_{1} & {β}_{1} & ⋯ & & 0 \\ {β}_{1} & {α}_{2} & ⋰ & & ⋮ \\ & ⋰ & ⋰ & ⋰ & \\ ⋮ & & ⋰ & ⋰ & {β}_{n - 1} \\ 0 & ⋯ & & {β}_{n - 1} & {α}_{n}\end{matrix} ] \qquad ( 76 )$$

and equating columns in AU=UT one arrives at the algorithm set forth in TABLE 2:

TABLE 2

r₀ = u₁
β₀ = 1
u₀ = 0
k = 0

while (βₖ ≠ 0)
uₖ₊₁ = rₖ/βₖ
k = k + 1
αₖ = u^{T}ₖAₖuₖ
rₖ = (A − αₖI)uₖ − βₖ₋₁uₖ₋₁
β_{k = ∥r}ₖ∥₂
end

Let A ε R^{n×n} be symmetric and assume u₁ ε Rⁿ has unit 2-norm. Then Lanczos iteration runs until k=m, where m=rank(K(A,u₁,n)). Moreover, for k=1:m as shown in equation 77:
AUₖ=UₖTₖ+rₖeₖ^{T} (77)
where, as shown in equation 78:

$${T}_{k} = [ \begin{matrix}{α}_{1} & {β}_{1} & … & & 0 \\ {β}_{1} & {α}_{2} & ⋰ & & ⋮ \\ & ⋰ & ⋰ & ⋰ & \\ ⋮ & & ⋰ & ⋰ & {β}_{k - 1} \\ 0 & … & & {β}_{k - 1} & {α}_{k}\end{matrix} ] \qquad ( 78 )$$

and Uₖ=[u₁, . . . uₖ] has orthonormal columns that span K (A,u₁,k).

Encountering a zero βₖ is a welcome event in that it signals the computation of an exact invariant subspace. However, an exact zero or even a small βₖ is a rarity in practice.

Suppose that k steps of Lanczos algorithm have been performed and that Sₖ^{T}TₖSₖ=diag(θ₁, . . . ,θₖ) is the Schur decomposition of the tridiagonal matrixTₖ. If Yₖ=[y₁, . . . yₖ]=UₖSₖ ε R^{n×k}, then for i=1:k ∥Ayᵢ−θᵢyᵢ∥₂=|βₖ∥Sₖᵢ| where if A be an n-by-n symmetric matrix with eigenvalues λ₁≧λ₂≧ . . . λₙ and corresponding orthonormal eigenvectorsz z₁, . . . ,zₙ. If θ₁≧θ₂≧ . . . ≧θₖ are the eigenvalues of the matrix Tₖ obtained after k of the Lanczos iteration, then equation 79 can be obtained:

$${λ}_{1} \geq {θ}_{1} \geq {λ}_{1} - \frac{( {λ}_{1} - {λ}_{n} ) {tan ( {ϕ}_{1} )}^{2}}{{( {c}_{k - 1} ( 1 + 2 {ρ}_{1} ) )}^{2}} \qquad ( 79 )$$

where cos(φ₁)=|u₁^{T}z₁|, ρ₁=(λ₁−λ₂)/λ₂−λₙ), and cₖ₋₁(x) is the Chebyshev polynomial of degree k−1.

Equation 80 can be obtained:

$${λ}_{n} \leq {θ}_{k} \leq {λ}_{n} + \frac{( {λ}_{1} - {λ}_{n} ) {tan ( {ϕ}_{n} )}^{2}}{{( {c}_{k - 1} ( 1 + 2 {ρ}_{n} ) )}^{2}} \qquad ( 80 )$$

where ρₙ=(λₙ₋₁−λₙ)/(λ₁−λₙ₋₁) and cos(φₙ)=|uₙ^{T}zₙ|.

The above discussion provides valuable insights into convergence and convergence rates of the eigenvalues of matrix Tₖ to those of A. The Chebyshev polynomials that are found in the denominator of equations 79 and 80 are bounded by unity on [−1, 1], but grow very rapidly outside this interval. Therefore, the convergence rates of this technique involving the tridiagonalization through Lanczos method are very fast, providing an efficient solution to the parent problem by effectively reducing the dimensions of the subspace search.

Another approach to solving the search for the optimum code set involves minimization of error of each user in the system until the overall MMSE of the system is minimized and convergence is achieved resulting in optimal code set. This minimization which is in effect solving Weiner Hopf equations is a unique minimizer of the cost function shown below. It is known that the error J produced by a transversal filter is given by equation 81:
J=σ_{b}_{ᵢ}²−s^{T}r_{y,b}_{ᵢ}s+s^{T}R_{y}s (81)
where σ_{b}_{ᵢ}² is the energy of the i^{th} users power, r_{y,b}_{ᵢ} is the cross correlation between the received signal and the i^{th} user's data bit and R_{y} is the correlation matrix of the received signal y. From equation 81 it can be seen that the filter function that minimizes the error function would minimize the following cost function in accordance with equation 82:

$$\begin{matrix}ψ ( s ) = \frac{1}{2} ( {s}^{T} {R}_{y} s ) - {s}^{T} {r}_{y , {b}_{i}} \\ = \frac{1}{2} ( {s}^{T} {A}_{i} s ) - {s}^{T} {s}_{i}\end{matrix} \qquad ( 82 )$$

The unique solution to equation 82 is contained in putting its gradient equal to zero. This results in finding the solution to the linear equation set forth in equation 83:
Aᵢs=sᵢ (83)

It follows from equation 83,
s=Aᵢ⁻¹sᵢ (84)

When the current code vector of a particular user is replaced with normalized version then the iterative algorithm is obtained. However, in order to reduce complexity of computing the inverse of the given correlation, it is desirable to derive an approximate solution.

Suppose s⁽⁰⁾ ε Rⁿ is the initial guess. One way to produce a vector sequence {s^{(k)}} that converges to s is to generate a sequence of orthonormal vectors {uₖ} which are the basis of the Krylov subspace and let s^{(k)} minimize ψ over the set
s⁽⁰⁾+span{u₁, . . . ,uₖ}=s⁽⁰⁾+span{u₁,Aᵢu₁ . . . ,Aᵢ^{k-1}u₁}
for k=1:n. If Uₖ=[u₁, . . . ,uₖ], then this just means choosing ω ε R^{k} such that, as shown in equation 85:

$$\begin{matrix}ψ ( {s}^{( 0 )} + {U}_{k} ω ) = \frac{1}{2} {( {s}^{( 0 )} + {U}_{k} ω )}^{T} {A}_{i} ( {s}^{( 0 )} + {U}_{k} ω ) - {( {s}^{( 0 )} + {U}_{k} ω )}^{T} {s}_{i} \\ = \frac{1}{2} {ω}^{T} ( {U}_{k}^{T} {A}_{i} {U}_{k} ) ω - {ω}^{T} {U}_{k}^{T} ( {s}_{i} - {A}_{i} {s}^{( 0 )} ) + ψ ( {s}^{( 0 )} )\end{matrix} \qquad ( 85 )$$

is minimized. By taking the gradient with respect to ω equation 86 is obtained:
s^{(k)}=s⁽⁰⁾+Uₖωₖ (86)
where, as shown in equation 87:
(Uₖ^{T}AᵢUₖ)ωₖ=Uₖ^{T}(sᵢ−Aᵢs⁽⁰⁾) (87)

When k=n the minimization is over all of Rⁿ and so Aᵢs⁽ⁿ⁾=sᵢ.

For a large sparse Aᵢ it may be necessary to overcome two hurdles in order to make this effective solution process:
The linear system should be easily solved
s^{(k)} should be computed without having to refer to u₁, . . . ,uₖ explicitly as equation 86 suggests. Otherwise there would be an excessive amount of data movement

This leads to the algorithm shown in TABLE 3 for an MMSE implementation:

TABLE 3

```
r⁽⁰⁾ = sᵢ − Aᵢs⁽⁰⁾
β₀ = ∥r⁽⁰⁾∥₂
u₀ = 0
k = 0
while βₖ ≠ 0
      uₖ₊₁ = r^{(k)}/βₖ
      k = k + 1
      αₖ = u^{T}ₖAᵢuₖ
      rₖ = (Aᵢ − αₖI)uₖ − βₖ₋₁uₖ₋₁
      βₖ = ∥rₖ∥₂
if k = 1
        d₁ = α₁
        c₁ = u₁
        ρ₁ = >₀α₁
        s⁽¹⁾ = ρ₁u₁
      else
      μₖ₋₁ = βₖ₋₁/dₖ₋₁
                dₖ = αₖ − βₖ₋₁μₖ₋₁
                cₖ = uₖ − μₖ₋₁cₖ₋₁
                ρₖ = − μₖ₋₁dₖ₋₁ρₖ₋₁/dₖ
                s^{(k)} = s^{(k-1)} + ρₖcₖ
        end
      end
      ŝᵢ = s^{(k)}
```

Simulations results for two cases are now described. For obtaining the sequences, IEEE 802.15.3a UWB channel type 2 (NLOS 4-10 m) was used. Channel impulse responses corresponding to different channels (1000 channels obtained) were generated and allotted to each user for transmission in different frequency bands. Channel impulse responses corresponding to a single sub-carrier class in each frequency band were then considered, for instance sub-carrier 1 in band 1, band 2, band 3, etc., for all the devices and an iterative TSC reduction MMSE algorithm was applied to obtain the final sequences as well as the power to be allocated to the given sub-carrier under consideration in different frequency bands. In order to circumvent allocation of large power for the channel in deep fade a simple power threshold was used in simulation to distribute the channel energy in other dimensions. The following tables show the code sequences and the normalized power which each user puts on the given sub-carrier. The codes were computed using algorithmic implementation for MMSE, Nᵥ=9, and K=10

TABLE 4 contains the code for the 10 users at the remote devices.

TABLE 4

| | | | | | | | | | |
|---|---|---|---|---|---|---|---|---|---|
| code 1 | −0.07011 | 0.41067 | −0.62808 | −0.67454 | −0.09687 | 0.030742 | 0.06029 | −0.94136 | −0.53269 |
| code 2 | −0.10877 | 0.16633 | 0.93579 | −0.09063 | 0.5876 | −0.28132 | 0.020508 | −0.40591 | −0.40667 |
| code 3 | 0.25733 | 0.27074 | 0.097551 | 0.51912 | 0.069651 | −0.20258 | −0.21639 | 0.65681 | −0.64744 |
| code 4 | −0.41948 | 0.2941 | 0.21528 | −0.0801 | 0.50562 | 0.84403 | −0.26525 | −0.74928 | −0.79075 |
| code 5 | −0.35121 | −0.41034 | −0.09994 | 0.2732 | 0.38074 | −0.93628 | 0.31375 | 0.31994 | −0.23184 |
| code 6 | −0.82017 | −0.2 | −0.91149 | 0.046573 | 0.10761 | −0.28645 | −0.92507 | −0.15111 | 0.30849 |
| code 7 | −0.27305 | 0.43259 | 0.92707 | 0.085158 | −0.1356 | −0.35151 | 0.36296 | −0.08447 | 0.23868 |
| code 8 | −0.26185 | 0.27633 | −0.2375 | 0.11262 | 0.061447 | 0.18434 | −0.42181 | 0.87519 | 0.78042 |
| code 9 | −0.27203 | 0.48945 | 0.20426 | −0.2794 | −0.17265 | −0.22001 | −0.21029 | 0.41562 | −0.31955 |
| code 10 | 0.13895 | 0.011701 | −0.21774 | −0.19344 | 0.23463 | 0.175 | 0.15251 | 0.22372 | 0.31796 |

TABLE 5 contains the code at the receiver side (central controller) after the signals pass through the channel.

TABLE 5

| | | | | | | | | | |
|---|---|---|---|---|---|---|---|---|---|
| code 1 | −0.03592 | 0.5488 | −0.63801 | −0.16507 | −0.24898 | 0.046559 | 0.1457 | −0.3737 | −0.19539 |
| code 2 | −0.15636 | 0.26007 | 0.17968 | −0.07752 | 0.60496 | −0.39316 | 0.021782 | −0.38029 | −0.45164 |
| code 3 | .49629 | 0.34023 | 0.10722 | 0.6079 | 0.086571 | −0.13346 | −0.32611 | 0.23473 | −0.26485 |
| code 4 | 0.23699 | 0.0083 | 0.4005 | −0.07656 | 0.092591 | 0.68074 | −0.38691 | −0.35299 | −0.17671 |
| code 5 | 0.5571 | −0.44038 | −0.20115 | 0.41336 | 0.043952 | −0.08764 | 0.24801 | 0.14988 | −0.43679 |
| code 6 | 0.11275 | −0.25947 | −0.15418 | 0.059979 | 0.1139 | −0.48914 | −0.49358 | −0.41375 | 0.47492 |
| code 7 | 0.2331 | 0.37794 | 0.52485 | 0.17664 | −0.04861 | −0.16072 | 0.54549 | −0.08545 | 0.40386 |
| code 8 | 0.59102 | 0.45266 | −0.19927 | 0.26119 | 0.071275 | 0.12757 | −0.36124 | 0.33389 | 0.27303 |
| code 9 | 0.19806 | 0.13206 | 0.21425 | −0.61873 | −0.15169 | −0.35818 | −0.25693 | 0.49435 | −0.23 |
| code 10 | .13025 | 0.005246 | −0.27305 | −0.21385 | 0.78849 | 0.23625 | 0.18486 | 0.30052 | 0.24635 |

The present invention enables increased user capacity and at the same time offers increased data capacity, e.g., if more than one code per user is allocated to allow transmission in all available slots along frequency and time axis. This can be done flexibly with power placed on sub carriers which use a strong channel. Since this is accomplished through a central controller, co-ordination in such a communication system which would involve a host of communication devices is simplified. Moreover, the computational complexity can be placed in this central receiver allowing simpler designs for the rest of the communicating devices.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A method for processing source data for transmission on wideband signal pulses of a multi-band wideband communication system, the multi-band wideband communication system including a plurality of communication slots separated by at least one of time or frequency, each communication slot associated with one or more wideband signal pulses, the method comprising the steps of:
generating OFDM symbols responsive to the source data, each OFDM symbol including a plurality of sub-carrier symbols;
obtaining a code including a plurality of components, each component corresponding to one of the plurality of communication slots;
independently combining one of the plurality of sub-carrier symbols with each component of the obtained code to encode that sub-carrier symbol; and
modulating a wideband signal pulse associated with each communication slot with the sub-carrier symbol combined with the component corresponding to that communication slot.

2. The method of claim 1, wherein the wideband communication system includes a central communication coordinator and wherein the method further comprises the step of:
receiving the code from the central communication coordinator.

3. The method of claim 2, further comprising the step of:
receiving a new code having a plurality of components from the central communication coordinator, each component associated with a corresponding one of the plurality of communication slots, the components of the new code generated responsive to receipt of the modulated wideband signal pulses; and
replacing the code with the new code.

4. The method of claim 1, wherein the communication slots are present in at least two bands of the multi-band wideband communication system.

5. The method of claim 1, wherein the communication slots are present in at least two time periods of the multi-band wideband communication system.

6. The method of claim 1, wherein the independently combining step comprises the step of:
independently multiplying the one sub-carrier symbols with each component of the obtained code.

7. A method for processing wideband signal pulses received from one or more remote devices over a multi-band wideband communication system, the multi-band wideband communication system including a plurality of communication slots separated by at least one of time or frequency, each communication slot associated with one or more of the wideband signal pulses, the wideband signal pulses carrying sub-carrier symbols from the one or more remote devices encoded over the plurality of communications slots using codes associated with each of the one or more remote devices, the method comprising the steps of:
receiving the wideband signal pulses associated with each of the plurality of communication slots;
demodulating the received wideband signal pulses; and
processing the demodulated wideband signal pulses for the plurality of communication slots using the codes associated with each of the one or more remote devices to detect the sub-carrier symbol for that remote device.

8. The method of claim 7, wherein the processing step comprises the steps of:
sampling at least one demodulated wideband signal pulse for each of the plurality of communication slots to obtain a data sample;
transforming the data sample from a time domain to a frequency domain; and
applying the codes associated with each of the one or more remote devices to the transformed data sample to detect the sub-carrier symbol for that device.

9. The method of claim 8, wherein the sampling step comprises the step of:
sampling an OFDM signal of demodulated wideband signal pulses.

10. The method of claim 8, further comprising the steps of:
estimating a channel for each of the wideband signal pulses;
generating a new code including components corresponding to each communication slot for each of the one or more remote devices responsive to the channel estimate; and
transmitting the new code to the respective one or more remote devices for use in encoding the data.

11. A method for generating codes to encode sub-carrier symbols of one or more remote devices over a plurality of communication slots in a wideband communication system, the plurality of communication slots separated by at least one of time or frequency, the method comprising the steps of:
estimating channel conditions associated with each of the one or more remote devices, the channel conditions corresponding to one or more frequencies in each of the plurality of communication slots;
filtering a current code for each of the one or more remote devices to develop a new code, the current code and the new code each including components corresponding to each of the communication slots;
comparing the current codes to the new codes for the one or more remote devices; and
transmitting the new code to one or more remote devices responsive to the comparison of the current codes to the new codes.

12. The method of claim 11, further comprising the step of:
generating a binary code for use as the current code prior to the filtering step.

13. The method of claim 11, wherein the comparing step comprises the step of comparing the total squared correlation (TSC) for the current codes to the TSC for the new codes and wherein the method further comprises the step of:
repeating the filtering and comparing steps and replacing the current codes with the new codes until the TSC for the current code is at least approximately equal to the TSC for the new codes.

14. A computer readable carrier including software that is configured to control a computer to implement a method embodied in a computer readable medium for processing source data for transmission on wideband signal pulses of a multi-band wideband communication system, the multi-band wideband communication system including a plurality of communication slots separated by at least one of time or frequency, each communication slot associated with one or more wideband signal pulses, the method comprising the steps of:
generating OFDM symbols responsive to the source data, each OFDM symbol including a plurality of sub-carrier symbols;
obtaining a code including a plurality of components, each component corresponding to one of the plurality of communication slots;
independently combining one of the plurality of sub-carrier symbols with each component of the obtained code to encode that sub-carrier symbol; and
modulating a wideband signal pulse associated with each communication slot with the sub-carrier symbol combined with the component corresponding to that communication slot.

15. The computer readable carrier of claim 14, wherein the wideband communication system includes a central communication coordinator and wherein the method implemented by the computer further comprises the step of:
receiving the code from the central communication coordinator.

16. The computer readable carrier of claim 15, wherein the method implemented by the computer further comprises the step of:
receiving a new code having a plurality of components from the central communication coordinator, each component associated with a corresponding one of the plurality of communication slots, the components of the new code generated responsive to receipt of the modulated wideband signal pulses; and
replacing the code with the new code.

17. The computer readable carrier of claim 14, wherein the independently combining step for implementation by the computer comprises the step of:
independently multiplying the one sub-carrier symbols with each component of the obtained code.

18. A computer readable carrier including software that is configured to control a computer to implement a method embodied in a computer readable medium for processing wideband signal pulses received from one or more remote devices over a multi-band wideband communication system, the multi-band wideband communication system including a plurality of communication slots separated by at least one of time or frequency, each communication slot associated with one or more of the wideband signal pulses, the wideband signal pulses carrying sub-carrier symbols from the one or more remote devices encoded over the plurality of communications slots using codes associated with each of the one or more remote devices, the method comprising the steps of:
receiving the wideband signal pulses associated with each of the plurality of communication slots;
demodulating the received wideband signal pulses; and
processing the demodulated wideband signal pulses for the plurality of communication slots using the codes associated with each of the one or more remote devices to detect the sub-carrier symbol for that remote device.

19. The computer readable carrier of claim 18, wherein the processing step for implementation by the computer comprises the steps of:
sampling at least one demodulated wideband signal pulse for each of the plurality of communication slots to obtain a data sample;
transforming the data sample from a time domain to a frequency domain; and
applying the codes associated with each of the one or more remote devices to the transformed data sample to detect the sub-carrier symbol for that device.

20. The computer readable carrier of claim 19, wherein the sampling step for implementation by the computer comprises the step of:
sampling an OFDM signal of demodulated wideband signal pulses.

21. The computer readable carrier of claim 19, wherein the method implemented by the computer further comprises the steps of:
estimating a channel for each of the wideband signal pulses;
generating a new code including components corresponding to each communication slot for each of the one or more remote devices responsive to the channel estimate; and
transmitting the new code to the respective one or more remote devices for use in encoding the data.

22. A computer readable carrier including software that is configured to control a computer to implement a method embodied in a computer readable medium for generating codes to encode sub-carrier symbols of one or more remote devices over a plurality of communication slots in a wideband communication system, the plurality of communication slots separated by at least one of time or frequency, the method comprising the steps of:
estimating channel conditions associated with each of the one or more remote devices, the channel conditions corresponding to one or more frequencies in each of the plurality of communication slots;
filtering a current code for each of the one or more remote devices to develop a new code, the current code and the new code each including components corresponding to each of the communication slots;
comparing the current codes to the new codes for the one or more remote devices; and
transmitting the new code to one or more remote devices responsive to the comparison of the current codes to the new codes.

23. The computer readable carrier of claim 22, wherein the method implemented by the computer further comprises the step of:
generating a binary code for use as the current code prior to the filtering step.

24. The computer readable carrier of claim 22, wherein the comparing step for implementation by the computer comprises the step of comparing the total squared correlation (TSC) for the current codes to the TSC for the new codes and wherein the method implemented by the computer further comprises the step of:
repeating the filtering and comparing steps and replacing the current codes with the new codes until the TSC for the current code is at least approximately equal to the TSC for the new codes.
